(19) United States
(12) Patent Application Publication
(10) Pub. No.: US 2023/0354795 A1
(43) Pub. Date: Nov. 9, 2023

(54) SYSTEM AND METHOD FOR MODELING CROP YIELD BASED ON DETECTION OF PLANT STRESSORS IN CROPS

(71) Applicant: InnerPlant, Inc., San Francisco, CA (US)

(72) Inventors: Shely Aronov, San Francisco, CA (US); Roderick Kumimoto, San Francisco, CA (US); Ari Kornfeld, San Francisco, CA (US); Randall Shultz, San Francisco, CA (US)

(21) Appl. No.: 18/144,087

(22) Filed: May 5, 2023

Related U.S. Application Data
(63) Continuation-in-part of application No. 17/592,275, filed on Feb. 3, 2022, now Pat. No. 11,737,443.
Application No. 17/592,275 is a continuation of application No. 17/217,840, filed on Mar. 30, 2021, now Pat. No. 11,602,141.
Application No. 17/217,840 is a continuation of application No. 16/908,526, filed on Jun. 22, 2020, now Pat. No. 10,986,827.
(60) Provisional application No. 63/417,247, filed on Oct. 18, 2022.
(60) Provisional application No. 63/338,618, filed on May 5, 2022.
(60) Provisional application No. 62/864,401, filed on Jun. 20, 2019.

(51) Int. Cl. A01M 1/02; A01N 63/14; G06Q 50/02; A01G 13/10; G06V 20/10

(52) U.S. Cl. CPC A01M 1/026; A01N 63/14; G06Q 50/02; A01G 13/10; G06V 20/188; G06T 2207/30188

(57) ABSTRACT

One variation of a method includes: accessing an image of sensor plants sown in crops of a crop type within a geographic region and configured to signal presence of a stressor; interpreting a first pressure of the stressor within a first subregion based on a first subset of features extracted from the image; interpreting a second pressure of the stressor in a second subregion based on a second subset of features extracted from the image; based on the first pressure and the second pressure, deriving a pressure map representing pressures of the stressor within the geographic region; accessing a yield model linking pressures of the stressor and crop yield for crops of the crop type in the geographic region; and predicting a crop yield for crops of the crop type in the geographic region based on the pressure map and the yield model.

### CROSS-REFERENCE TO RELATED APPLICATIONS

This application claims the benefit of U.S. Provisional Application No. 63/417,247, filed on 18 Oct. 2022, and U.S. Provisional Application No. 63/338,618, filed on 5 May 2022, each of which is incorporated in its entirety by this reference.

This application is also a Continuation-In-Part Application of U.S. patent application Ser. No. 17/592,275, filed on 3 Feb. 2022, which is a continuation application of U.S. patent application Ser. No. 17/217,840, filed on 30 Mar. 2021, which is a continuation application of U.S. patent application Ser. No. 16/908,526, filed on 22 Jun. 2020, which claims the benefit of U.S. Provisional Application No. 62/864,401, filed on 20 Jun. 2019, each of which is incorporated in its entirety by this reference.

### TECHNICAL FIELD

This invention relates generally to the field of agriculture and more specifically to a new and useful method for detecting stressors in crops and modeling crop yield in the field of agriculture.

### BRIEF DESCRIPTION OF THE FIGURES

FIG. 1 is a flowchart representation of a method;

FIGS. 2A and 2B are flowchart representations of one variation of the method;

FIG. 3 is a flowchart representation of one variation of the method;

FIGS. 4A and 4B are flowchart representations of one variation of the method; and

FIG. 5 is a flowchart representation of one variation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

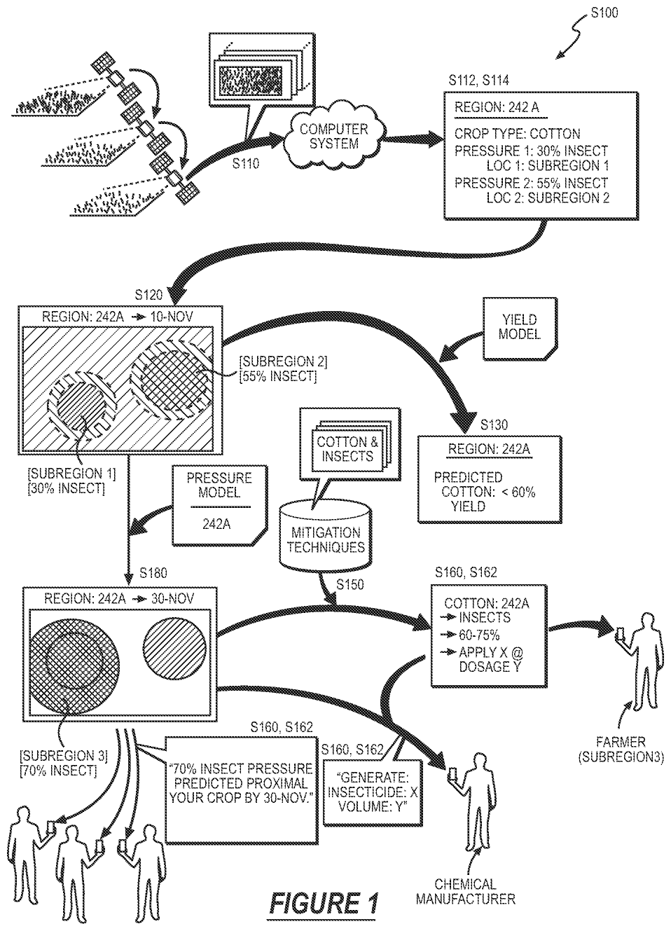

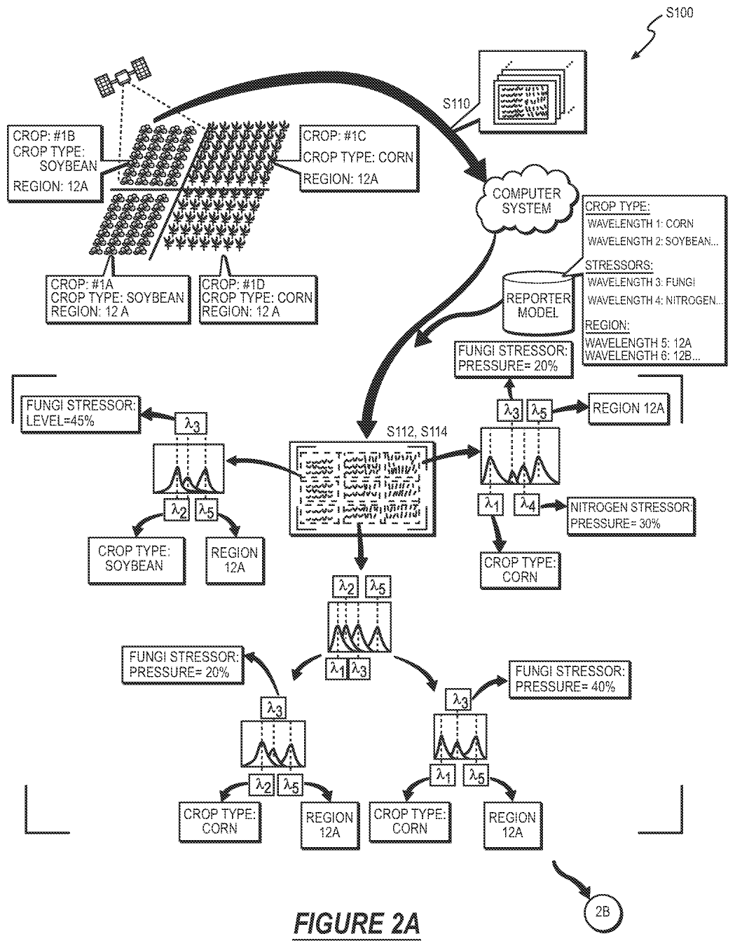

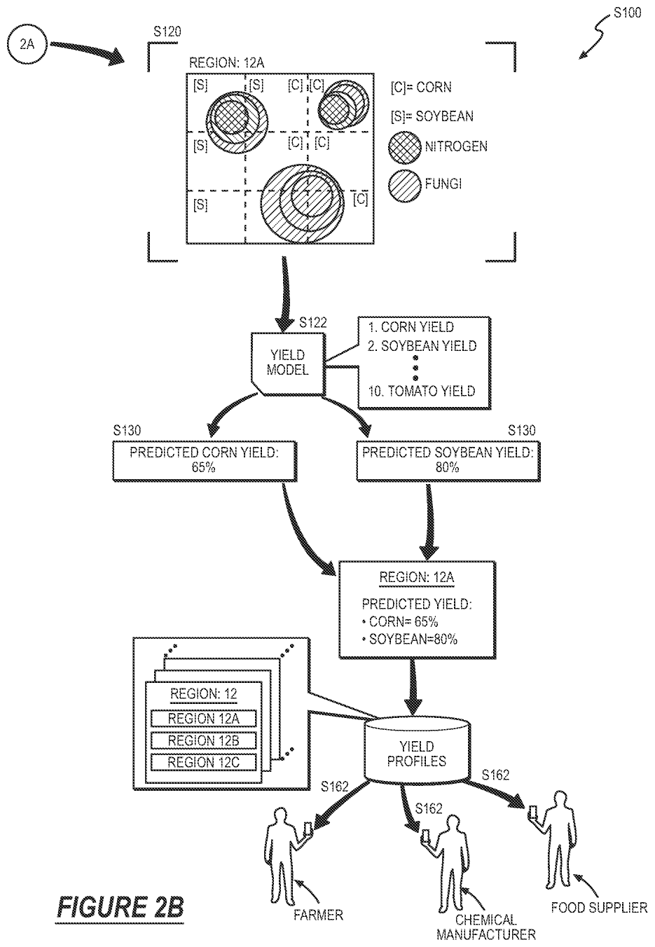

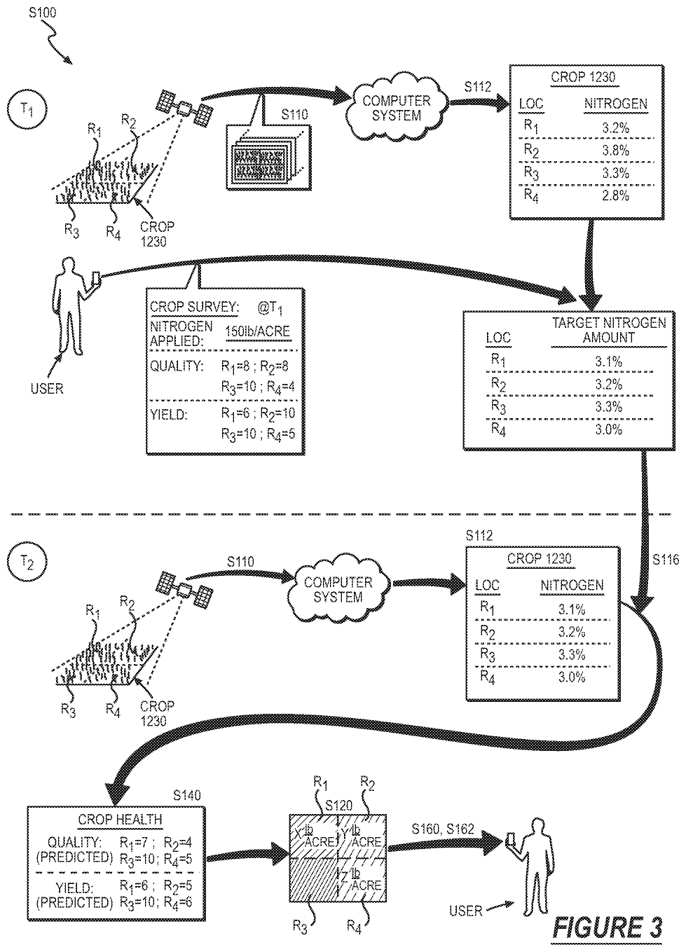

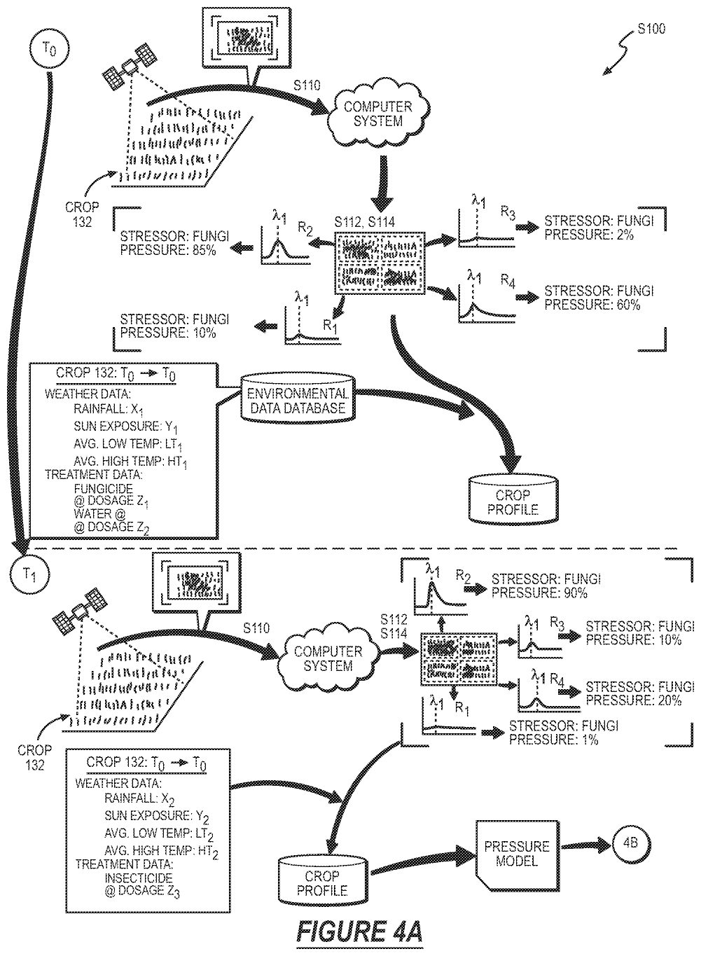

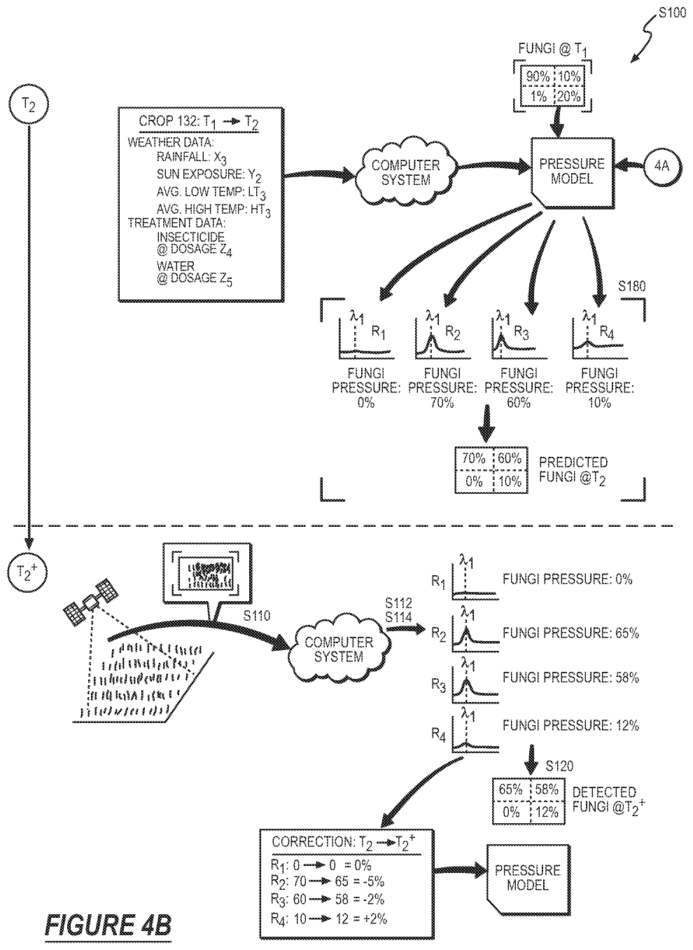

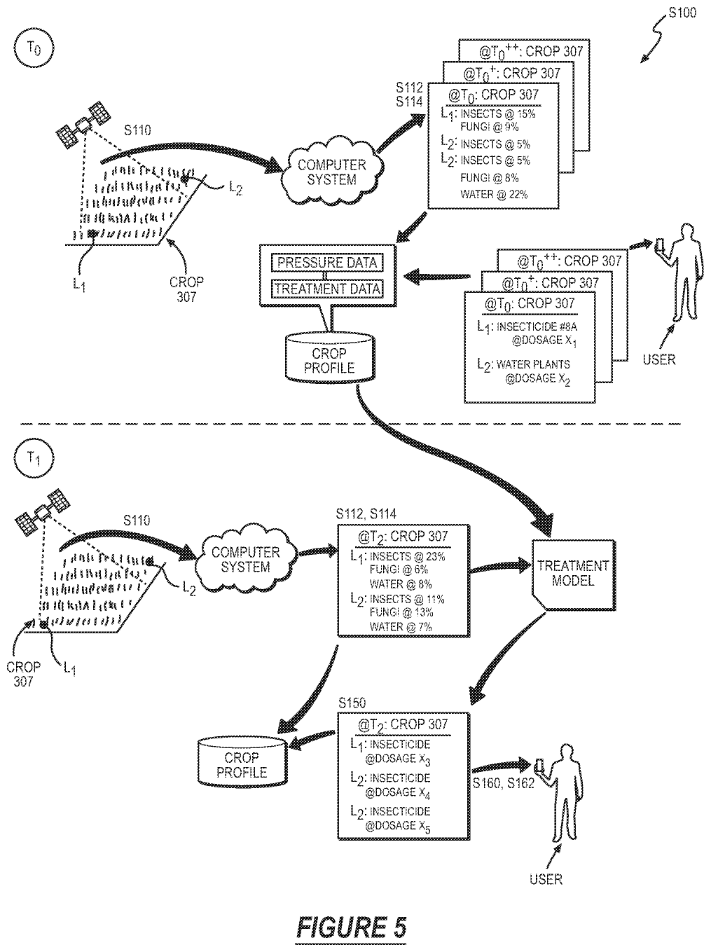

As shown in FIGS. 1, 2A, 2B, 3, 4A, 4B, and 5, a method S100 includes: accessing a feed of images of sensor plants of a sensor plant type sown in a set of agricultural fields within a geographic region, the feed of images recorded during a first time period, sensor plants of the sensor plant type configured to signal presence of a set of stressors at sensor plants in Block Silo; interpreting a first pressure of a first stressor, in the set of stressors, in a first subregion, within the geographic region, based on features extracted from a first subset of images, in the feed of images, depicting sensor plants in the first subregion in Block S112; interpreting a second pressure of the first stressor in a second subregion, within the geographic region, based on features extracted from a second subset of images, in the feed of images, depicting sensor plants in the second subregion in Block S112; deriving a first pressure map for the geographic region based on the first pressure and the second pressure, the first pressure map representative of presence of the set of stressors within the geographic region during the first time period in Block S120; accessing a yield model linking pressures of the set of stressors within the geographic region and crop yield for crops of a set of crop types in the target region in Block S122; and predicting a first crop yield for crops of a first crop type, in the set of crop types, in the geographic region based on the first pressure map and the yield model in Block S130.

One variation of the method S100 includes: accessing a feed of images of a population of sensor plants sown in an agricultural field of a crop type, the feed of images recorded by an aerial sensor during a first time period, the population of sensor plants configured to signal presence of a set of conditions and including a first set of sensor plants arranged in a first region of the agricultural field in Block Silo; interpreting a first set of conditions at plants in the first region based on features extracted from a first subset of images, in the feed of images, depicting sensor plants in the first region in Block S112; accessing a set of target conditions defined for plants in the first region of the agricultural field in Block S116; predicting a first health score for plants in the first region based on a first difference between the first set of conditions and the set of target conditions in Block S140; based on the first health score, selecting a first treatment pathway, in a set of treatment pathways, for plants in the first subregion, the first treatment pathway configured to drive conditions of plants in the agricultural field toward the set of target conditions in Block S150; generating a prompt to implement the first treatment pathway during a second time period succeeding the first time period in Block S160; and transmitting the prompt to a user affiliated with the agricultural field in Block S162.

One variation of the method S100 includes: accessing a feed of images of a population of sensor plants sown in crops of a crop type within a target region and configured to signal presence of a set of stressors at sensor plants, the feed of images captured by an optical sensor during a first time period in Block Silo; interpreting a first timeseries of pressure data for plants in a first subregion, in a set of subregions, of the target region based on features extracted from a first subset of images, in the feed of images, captured during a first time period, the first timeseries of pressure data representing changes in pressures of a set of stressors at plants in the first subregion during the first time period in Block S112; interpreting a second timeseries of pressure data for plants in a second subregion, in the set of subregions, of the target region based on features extracted from a second subset of images, in the feed of images, captured during the first time period, the second timeseries of pressure data representing changes in pressures of the set of stressors at plants in the second subregion during the first time period in Block S114; accessing a yield model linking pressures of the set of stressors in the target region and crop yield for crops of a set of crop types in the target region in Block S122; and predicting a first crop yield for crops of a first crop type, in the set of crop types, in the target region, during a target harvest period succeeding the first time period, based on the first timeseries of pressure data, the second timeseries of pressure data, and the yield model in Block S130.

One variation of the method S100 includes: accessing a feed of images of a population of sensor plants sown in crops of a crop type within a target region and configured to signal presence of a set of stressors at sensor plants, the feed of images captured by an optical sensor during a first time period in Block Silo; interpreting a first pressure of a first stressor, in the set of stressors, in a first subregion, within the target region, based on features extracted from a first subset of images, in the feed of images, depicting a first set of sensor plants in the population of sensor plants in Block S112; interpreting a second pressure of the first stressor in a second subregion, within the target region, based on features extracted from a second subset of images, in the feed of images, depicting a second set of sensor plants in the population of sensor plants in Block S114; deriving a first pressure map for the target region during the first time period based on the first pressure and the second pressure in Block S120; accessing a yield model linking pressures of the first stressor and crop yield for crops of the crop type in the target region in Block S122; and predicting a first crop yield for crops of the crop type in the target region, during a target harvest period succeeding the first time period, based on the first pressure map and the yield model in Block S130.

One variation of the method S100 includes: accessing a feed of images—recorded by an aerial sensor during a first time period—of a population of sensor plants sown in an agricultural field of a crop type (e.g., cotton, soybean, corn), the population of sensor plants configured to signal presence of a set of conditions in Block S110, the population of sensor plants including a first set of sensor plants arranged in a first subregion of the agricultural field and a second set of sensor plants arranged in a second subregion of the agricultural field; interpreting a first set of conditions at plants in the first subregion based on a first set of plant signals (e.g., a fluorescence signal) detected in a first subset of images, in the feed of images, depicting sensor plants in the first subregion in Block S112; and interpreting a second set of conditions at plants in the second subregion based on a second set of signals (e.g., a fluorescence signal) detected in a second subset of images, in the feed of images, depicting sensor plants in the second subregion in Block S114. The method S100 further includes: accessing a first set of target conditions defined for plants in the first subregion in Block S116; predicting a first health score for plants in the first subregion of the agricultural field based on a first difference between the first set of conditions and the first set of target conditions in Block S140; and, based on the first health score, selecting a first treatment pathway for plants in the first subregion in Block S150.

In the preceding variation, the method S100 further includes: accessing a second set of target conditions defined for plants in the second subregion in Block S116; predicting a second health score for plants in the second subregion of the agricultural field based on a second difference between the second set of conditions and the second set of target conditions in Block S140; and, based on the second health score, selecting a second treatment pathway for plants in the second subregion in Block S150. In one variation, the method S100 further includes: assembling a treatment map—specifying a location and a magnitude (e.g., frequency and/or amount) of application for each treatment pathway selected for the crop—based on the first treatment pathway selected for the first subregion and the second treatment pathway selected for the second subregion in Block S170.

One variation of the method S100 includes: accessing a feed of images—recorded by an aerial sensor during a first time period—of a population of sensor plants sown in crops of a crop type (e.g., cotton, soybean, corn) within a target region (e.g., a target geographic region), the population of sensor plants configured to signal presence of a set of stressors (e.g., abiotic and/or biotic stressors) at sensor plants in Block Silo; interpreting a first pressure of a first stressor, in the set of stressors, in a first subregion, within the target region, based on a first signal (e.g., a fluorescent signal) detected in a first subset of images, in the feed of images, depicting sensor plants in the first subregion in Block S112; interpreting a second pressure of the first stressor in a second subregion, within the target region, based on a second signal (e.g., a fluorescent signal) detected in a second subset of images, in the feed of images, depicting sensor plants in the second subregion in Block S114; deriving a first pressure map for the target region—during the first time period—based on the first pressure and the second pressure in Block S120; accessing a yield model linking pressures of the first stressor and crop yield for crops of the crop type in the target region in Block S122; and predicting a first crop yield for crops of the crop type in the target region—during a target harvest period succeeding the first time period—based on the first pressure map and the yield model in Block S130.

In one variation, the method S100 further includes: accessing a pressure model configured to predict future pressures of the first stressor in the target region based on detected pressures of the first stressor in the target region; and predicting a second pressure map for the target region—during a second time period succeeding the first time period—based on the first pressure map and the pressure model in Block S180. In response to the second pressure map predicting a third pressure—exceeding a threshold pressure—of the first stressor in a third subregion within the target region, the method S100 further includes: transmitting a first prompt—to implement a first mitigation technique, in a set of mitigation techniques, configured to mitigate pressures of the first stressor—to a first set of users associated with maintenance of crops located within the third subregion in Blocks S160 and S162; transmitting a second prompt—to generate supply of a first crop treatment corresponding to the first mitigation technique and configured to treat pressures of the first stressor—to a second set of users associated with manufacturing of crop treatments in Blocks S160 and S162; and notifying a third set of users—associated with maintenance of crops proximal the third subregion—of prediction of the third pressure of the first stressor in the third subregion during the second time period in Blocks S160 and S162.

### 2. Applications

Generally, Blocks of the method S100 can be executed by a computer system (e.g., a remote server, a local computing device, a computer network) in cooperation with a sensor plant platform (e.g., a native application or web-based application) to: detect signals generated by sensor plants; interpret (e.g., estimate) pressures of stressors at sensor plants sown in crops, across multiple crops, and/or across a particular geographical region based on these sensor plant signals; derive a set of crop models—for a particular crop and/or for a particular region of crops—configured to predict various indicators of crop health and/or crop operation, such as presence of stressors in the crop, crop yield (e.g., for a particular growing season), and/or crop resilience (e.g., speed and/or magnitude of stressor mitigation); and selectively distribute insights, instructions and/or suggestions related to detection of stressors in crops to various users associated with a crop supply chain via the sensor plant platform.

For example, the computer system—in cooperation with the sensor plant platform—can selectively distribute prompts to both local users (e.g., farmers, agronomists, researchers) associated with crops proximal or containing these sensor plants and/or users in various sectors or industries linked to a supply chain associated with these crops, such as users associated with food, clothing or textile, distribution (e.g., trucking, shipping, storage), health, government, insurance, and/or chemical industries.

In one implementation, the system can: access images (e.g., satellite or aerial color or infrared images) of agricultural fields; scan these images for signals indicative of sensor plants (e.g., fluorescence in a particular spectrum characteristic of the sensor plants or characteristic of a particular stressor present at the sensor plants); identify a population of sensor plants sown in a particular geographic region depicted in these images based on such characteristic signals (or “baseline signals”) detected in these images; and interpret pressures of stressors within this population of sensor plants based on presence and/or amplitudes of optical signals present at these sensor plants; and assemble a pressure map—depicting pressures of a set of stressors in the population of sensor plants during a particular time period—for the particular geographic region.

The system can continue to access images of sensor plants in the population of sensor plants over time to assemble timeseries of pressure data for this particular geographic region. The system can then leverage these timeseries of pressure data—in combination with timeseries of pressure data collected for numerous populations of sensor plants spanning numerous crops and/or many regions—to predict future pressures of stressors in this particular geographic region based on the current pressure map. The system can also fuse this timeseries of pressure data with other data collected for this particular geographic region, such as timeseries weather data and/or timeseries crop treatment data—to predict future pressures of stressors in this particular region as a function of (current) detected pressures, applied crop treatments, average air temperature, average humidity, average rainfall, etc., corresponding to the particular geographic region.

Furthermore, the system can estimate changes in expected crop yield based on detection and/or prediction of pressures of stressors in this particular geographic region, such as based on historical crop data—including timeseries of pressure data and/or corresponding timeseries crop yield data—collected for this particular geographic region. Therefore, based on these predicted pressures of stressors and/or changes in expected crop yield, the system can selectively generate and distribute prompts to users related to detection and/or mitigation of crops in this particular geographic region.

### 2.1 Regional Modeling

In one implementation, the system can leverage fluorescence signals expressed by sensor plants distributed throughout a geographic region—such as sown across several crops and/or agricultural fields within the geographic region—to derive insights into crop health, spread and/or distribution of pressures of stressors (e.g., insects, fungi, dehydration, flooding, heat stress, cold stress, soil stressors) within this geographic region, and/or crop yield of crops of varying crop types.

For example, the system can: access images (e.g., spectral images) of sensor plants sown in crops throughout a geographic region; extract features—such as intensities of fluorescence at particular wavelengths—indicative of pressures of one or more stressors in sensor plants in this geographic region; interpolate or extrapolate these pressures of stressors in sensor plants to other plants (e.g., sensor and non-sensor plants) in the same geographic region; and detect and/or predict changes in these pressures of the set of stressors over time to predict crop yield for crops of each crop type within the geographic region. The system can thus: derive a yield profile for the geographic region defining predicted crop yields for each crop type (e.g., soybean, tomato, corn, cotton) present in the geographic region; and share this predicted yield profile with users—such as a farmer, a food supplier, a food-processing facility manager, a pesticide and/or fertilizer manufacturer, etc.—affiliated with crops in the geographic region, thereby enabling these users to better predict outcomes associated with crops in this particular geographic region.

### 2.2 Local Crop Modeling

Additionally or alternatively, in another implementation, the system can leverage fluorescence signals expressed by sensor plants sown within a particular crop or agricultural field to derive insights into crop health, spread and/or distribution of pressures of stressors within this crop, and/or crop yield for this particular crop. In particular, the system can leverage timeseries crop data—including timeseries pressure data, timeseries environmental data (e.g., weather data, treatment data), timeseries yield data, etc.—collected over one or more growing cycles for a crop to: derive high-resolution pressure maps—representative of pressures and/or pressure gradients of stressors at plants in various regions of the crop—for this crop; predict future pressures of stressors in different regions of the crop; characterize health of individual plants or groups of plants within the crop; predict yield for the crop for a particular growing cycle based on health of plants in the crop over time; and/or suggest tailored crop treatments—predicted to mitigates pressures of stressors in the crop—for different regions of the crop to more precisely regulate health of plants throughout the crop.

Further, in this implementation, the system can leverage timeseries crop data collected for the crop to derive a set of target plant conditions (e.g., soil pH, nitrogen levels in soil, irrigation levels, fertilizer levels, pest population size, fungi growth)—predicted to maximize crop yield for this particular crop—for plants within the crop and/or for particular groups of plants located in different regions of the crop. The system can then detect deviations from the set of target conditions in different regions of the crop (e.g., throughout a growing cycle) and thus selectively suggest treatments—for implementation in specific regions of the crop—configured to drive plant conditions in these regions toward the set of target plant conditions. Therefore, by promoting alignment of plant conditions throughout the crop with the set of target conditions derived for this particular crop, the system can drive crop yield toward a maximum crop yield predicted for this crop.

### 3. Sensor Plant

Generally, a sensor plant includes a promoter-reporter pair configured to detect stressors present in the sensor plant and to produce a detectable signal (e.g., in the electromagnetic spectrum) to indicate presence of these stressors in the sensor plant or in a region of a crop where the sensor plant is located more generally. In particular, a sensor plant can be genetically engineered to include: a promoter gene sequence (hereinafter a “promoter”) configured to activate in the presence of (e.g., “linked to”) a particular stressor; and a reporter gene sequence (hereinafter a “reporter”)—configured to activate responsive to activation of the promoter—encoding for a particular molecule (e.g., a fluorescent molecule) configured to express a detectable signal (e.g., a fluorescent signal). This promoter-reporter pair can be incorporated into the sensor plant via genetic engineering techniques that associate expression of a promoter responsive to a particular biological stress with a reporter that produces a measurable signal when the promoter expresses.

In one implementation, the sensor plant can be configured to include a promoter-reporter pair configured to signal presence of particular biotic and/or abiotic pressures experienced by the sensor plant, such as pest, disease, water, heat, soil health, and/or nutrient stresses or deficiencies. For example, the sensor plant can be genetically engineered to include a promoter with activity linked to presence of one stressor at the plant, such as a fungal, bacteria, pest, heat, water (e.g., dehydration and/or excessive hydration), disease, or nutrient stress (e.g., nutrient deficiency), phytoplasmal disease, poor soil health (e.g., soil pH), etc. The sensor plant can also be genetically engineered to include a reporter paired with the promoter and configured to produce a detectable signal such as an electromagnetic signal (e.g., fluorescent signal) in the visible light or infrared spectrum—when the corresponding promoter is activated. For example, the sensor plant can be genetically engineered to fluoresce (i.e., absorb photons at one frequency and emit photons at a different frequency) in the presence of (and proportional to) a pressure of a particular stressor. Therefore, via expression of the reporter, the promoter-reporter pair can produce a measurable signal of a particular biological stress or trait in the sensor plant.

In another implementation, the sensor plant can be genetically engineered to include multiple promoter-reporter pairs, each promoter-reporter pair indicative of a particular biological process occurring in the sensor plant cells in response to a particular stressor. For example, the sensor plant can include: a first promoter-reporter pair including a first promoter representative of a first biological process linked to presence of a water stressor tagged to a red fluorescence protein reporter; and a second promoter-reporter pair including a second promoter representative of a second biological process linked to presence of a fungal stressor tagged to a yellow fluorescence protein reporter. Therefore, the sensor plant can signal presence of multiple stressors via genetic modification of the sensor plant cells to include a set of promoter-reporter pairs.

In one variation, the sensor plant can be genetically engineered to include a multiplexed gene sensing network representative of a set of combinatorial promoter-reporter pairs. In this variation, the sensor plant can leverage a small number of reporters (e.g., fluorescing compounds) to monitor and detect a greater number of promoters and/or biological processes and therefore simplify the detection process by reducing the number of reporters required, as fluorescent compounds exhibit broad spectral features and may be difficult to simultaneously measure and distinguish between a large number of these fluorescent compounds.

### 3.1 Variation: Plant Identifier

In one variation, a population of sensor plants can be genetically modified to express a detectable, baseline signal (e.g., a fluorescent signal) associated with sensor plants in this population of sensor plants. In particular, a genome of each sensor plant, in the population of sensor plants, can be modified to include an identifier gene (hereinafter an “identifier”) configured to express the baseline signal (e.g., a fluorescence signal)—such as independent of stressor presence at sensor plants in the population of sensor plants—containing identifying information (e.g., crop location, sensor type, crop type) for this sensor plant.

In one implementation, the population of sensor plants can be configured to express a baseline signal characteristic of sensor plants grown in a particular region. For example, a first population of sensor plants can be configured to express a first baseline signal—corresponding to fluorescence within a first wavelength range—linked to a first geographic region. A second population of sensor plants can be configured to express a second baseline signal—corresponding to fluorescence within a second wavelength range distinct from the first wavelength range—linked to a second geographic region. The system can therefore: access an image and/or images of a greater geographic region including the first and second geographic regions; differentiate between sensor plants in the first geographic region and sensor plants in the second geographic region based on detection of the first and second baseline signal in these images; and thus interpret pressures of stressors, generate pressure maps, derive yield predictions, etc. for both the first and second geographic regions.

In particular, in one example, a population of sensor plants can be genetically modified to include a fluorescent tag configured to express a first fluorescent signal (e.g., red, yellow, and/or green fluorescence) within a first wavelength range (e.g., in the presence of light). The system can link this fluorescent tag—and corresponding first fluorescent signal—to a first region and/or crop containing the population of sensor plants. In particular, in this example, the system can store a first fluorescent light spectrum—depicting the fluorescent signal within the first wavelength range—in a first regional crop profile, in a set of regional crop profiles, associated with the first region. The system can then link this sensor plant—and/or a population of sensor plants including the sensor plant—to the first fluorescent signal within the first wavelength range. Later, the system can: access a feed of images recorded by an aerial sensor (e.g., a satellite) of a geographic region including this sensor plant and/or this population of sensor plants; and identify the sensor plant and/or this population of sensor plants in images, from the feed of images, based on detection of the first fluorescent signal (i.e., the baseline signal) expressed by sensor plants.

The system can also append the first regional crop profile with: a sensor plant type of sensor plants in the population of sensor plants, such as including a particular promoter-reporter pair configured to signal detection of a particular stressor, in a set of stressors; and/or a crop type (e.g., cotton, corn, soybean, grapes) of sensor plants in the population of sensor plants. The population of sensor plants (e.g., sensor plant seeds and/or sensor plant seedlings) can then be distributed (e.g., planted) in a crop (e.g., by a farmer or other user associated with the crop) and/or crops within the first region. Later (e.g., during growing of the population of sensor plants in the crop and/or crop), the system can access a feed of images of the first region recorded by a satellite at approximately a target frequency (e.g., weekly, biweekly, monthly). Then, in response to detecting a fluorescent signal in a first image, in the feed of images, the system can: access the set of regional crop profiles; and, in response to the detected fluorescent signal corresponding to the first fluorescent signal within the first wavelength range, identify the detected fluorescent signal as corresponding to the population of sensor plants of the sensor plant type and/or of the crop type located in the first region.

Further, in the preceding example, the population of sensor plants can be genetically modified to include the promoter-reporter pair configured to signal detection of the first stressor at the sensor plant, the promoter-reporter pair including: a promoter configured to express responsive to detection of the first stressor; and a reporter configured to express a second fluorescent signal within a second wavelength range—distinct from the first wavelength range—responsive to expression of the promoter. Therefore, in this example, the sensor plant can be configured to include the first fluorescent tag configured to express the first fluorescent signal within the first wavelength range, such that expression of the first fluorescent signal does not interfere with detection of the second fluorescent signal indicative of presence of the first stressor, thereby reducing error due to detection of additive or overlapping fluorescent signals.

Additionally or alternatively, in another implementation, each population of sensor plants can be configured to express a baseline signal linked to a particular crop type in a set of crop types. For example, a first population of sensor plants can be configured to express a first baseline signal—corresponding to fluorescence within a first wavelength range—linked to a first crop type (e.g., soybean). A second population of sensor plants can be configured to express a second baseline signal—corresponding to fluorescence within a second wavelength range distinct from the first wavelength range—linked to a second crop type (e.g., tomato). The system can therefore: access an image and/or images of a region including crops of the first and second crop type; differentiate between sensor plants of the first crop type and sensor plants of the second crop type based on detection of the first and second baseline signal in these images; and thus interpret pressures of stressors, generate pressure maps, derive yield predictions, etc. for crops of the first crop type and crops of the second crop type.

Additionally or alternatively, in one variation, the sensor plant can be genetically modified to include an identifier configured to express a detectable signal (e.g., a fluorescent signal) linked to a growth stage of the sensor plant. Additionally, in this variation, the sensor plant can be genetically modified to include a set of identifiers, each identifier, in the set of identifiers, configured to express a detectable signal, in a set of detectable signals, linked to a particular growth stage of the sensor plant. For example, the sensor plant and/or a population of sensor plants can be configured to include: a first identifier configured to express a first baseline signal during an initial growth stage (e.g., seed, seedling, and/or early vegetative phase); a second identifier configured to express a second baseline signal during a primary growth stage (e.g., budding and/or flowering stage); and a third identifier configured to express a third baseline signal during a final growth stage (e.g., ripening). The system can therefore track growth of the sensor plant throughout a life cycle of the sensor plant and derive insights and information related to crop health and/or yield for a particular crop based on detection of these baseline signals at various stages of the life cycle of the sensor plant

### 4. Stressor Detection

The system can detect and interpret signals generated by sensor plants by extracting features from images of sensor plants that correlate to presence of particular stressors at the sensor plants. More specifically, the system can access digital images (e.g., spectral images) of a sensor plant(s) and/or plant canopy (e.g., sensor plants and surrounding plants) captured by an optical sensor (e.g., a multispectral or hyperspectral imaging device) to detect reporter signals and interpret stressors present in these sensor plants based on these reporter signals.

In particular, an optical device can record optical signals generated by the sensor plant (e.g., in the form of color or multispectral images); and the computer system can extract features (e.g., intensities at particular wavelengths) from these images, interpret presence and/or magnitude of a particular stressor exposed to the sensor plant based on these features, and interpolate or extrapolate health and environmental conditions at other plants nearby (e.g., non-sensor plants; other unimaged sensor plants) based on presence and/or magnitude of the stressor thus indicated by the sensor plant.

For example, the computer system can extract intensities of particular wavelengths corresponding to specific compounds (e.g., proteins) in the sensor plant and interpret a pressure of a particular stressor exposed to the sensor plant based on intensities of these wavelengths—such as based on a stored model linking plant stressors to wavelengths of interest based on known characteristics of promoter and reporter genes in the sensor plant—and before such stressors are visually discernible in the visible spectrum (i.e., with an unaided human eye). The computer system can also interpolate or extrapolate presence or magnitude of these stressors in other plants near this sensor plant to predict overall health of a crop or agricultural field.

In particular, in one example, the system can: access a first subset of images (e.g., one image, a series of images) of sensor plants—configured to signal pressures of a set of stressors in plants—sown in agricultural fields within a geographic region; extract a first set of fluorescence measurements—such as a first set of fluorescence intensities—corresponding to a first wavelength range from the first subset of images; extract a second set of fluorescence measurements—such as a second set of fluorescence intensities—corresponding to a second wavelength range from the first subset of images; interpret a first pressure of a first stressor, in a set of stressors, in plants within the geographic region based on the first set of fluorescence measurements; and interpret a second pressure of a second stressor, in the set of stressors, in plants in the geographic region based on the second set of fluorescence measurements.

The system can access images of sensor plants captured by an optical sensor, such as from a handheld camera, a handheld spectrometer, a mobile phone, a UAV, a satellite, or from any other device that includes a high-resolution spectrometer, includes band-specific filters, or is otherwise configured to detect wavelengths of electromagnetic radiation fluorescence, luminescence, or any other optical signal emitted by the sensor plant in the presence of a particular stressor. More specifically, the system can: access hyperspectral images—of a leaf area of a sensor plant, a whole sensor plant, a group of like sensor plants, a whole crop of sensor plants, or many fields of sensor plants—recorded by a remote sensing system (e.g., a satellite, in an aircraft, in manned or unmanned field equipment such as a tractor, in a handheld device, in a boom or pole installed in the field); extract spectral characteristics for these hyperspectral images; and interpret presence and/or magnitude of a particular stressor(s) present at the sensor plant, group of plants, crop, or fields based on correlations between spectral characteristics extracted from these hyperspectral images and known characteristics (e.g., fluorescence) expressed by a particular promoter-reporter pair in this sensor plant.

### 5. Sensor Plant Platform

The system can compile multitudes of crop data—such as historical and/or (near) real time pressure data, treatment data, environmental data, and/or crop yield data—collected for populations of sensor plants planted, grown, and/or harvested across multiple crops and/or multiple regions (e.g., geographic regions), to derive insights and additional information related to crop health, supply, and/or management practices for a particular crop, a particular region, and/or a global crop supply.

The system can serve these data, instructions, insights, suggestions, information and/or recommendations to users associated with a particular crop, region of crops, and/or crop type—such as a farmer, a food supplier, an insurance agent (e.g., associated with farm assessment), a retailer, etc.—thus enabling these users to monitor pressures of stressors in these crops and/or mitigate risk associated with these pressures.

### 5.1 Crop Profile

In one implementation, the system can compile sensor plant data collected for a particular crop and/or a particular region (e.g., including many crops) over time into a crop profile, in a set of crop profiles, for this particular crop and/or region. This crop profile can thus include information representing historical sensor plant data for a crop such as: types of stressors detected, pressures of stressors detected, changes in pressures of stressors detected over time, etc.

The system can also collect additional information regarding the crop from the user, such as: a timeframe during which the crop was planted; a timeframe during which the crop will be harvested; frequency of irrigation; volume of irrigation; types of treatments typically applied to the crop; information regarding soil health; information regarding nutrients for the crop; etc. Therefore, with this additional information, the system can estimate pressures for this crop with increased sensitivity and increased confidence, thereby enabling the user to be more confident in information provided by the system and gain additional and more-precise insights and information regarding health of the crop.

### 5.1.1 Baseline Pressure Curve

In one variation, the system can identify patterns and/or trends in sensor plant data collected over time (e.g., over a growing period) for a particular crop or region. In particular, in this implementation, the system can leverage sensor plant data—collected for a particular crop or region over one or more growing periods—to derive a baseline pressure curve (e.g., an annual pressure curve) representative of detected or expected changes in pressures of stressors in this particular crop or region during a particular time period, such as corresponding to a growing period and/or a particular time of year.

For example, during a first growing season for a crop, the system can: monitor reporter signals expressed by sensor plants sown in the crop; leverage detection of these reporter signals over time to derive a timeseries of pressures of a set of stressors at set intervals (e.g., once per week, biweekly, once per month); and—based on the timeseries of pressures of the set of stressors—extract insights and information pertaining to: water movement across the crop; sun exposure across the crop (e.g., daily, weekly, monthly, seasonally); and timing and/or movements of pressures of other stressors such as insects, fungi, and/or nutrient deficiencies. The computer system can thus assemble timeseries of pressure and/or stressor data—corresponding to water movement, sun exposure, and/or pressures of other stressors—into a set of baseline pressure curves for the set of stressors in this particular crop. The system can then access these baseline pressure curves to: predict conditions of the crop and/or region at a start of and/or throughout subsequent growing seasons; and/or suggest implementation of farming practices and/or stressor treatments at this crop based on predicted plant conditions.

In one implementation, during a first growing cycle for plants sown within a first region (e.g., a crop, an agricultural field, a geographic region), the system can: interpret a first set of pressures of a set of stressors—each pressure, in the first set of pressures, corresponding to a particular stressor in the set of stressors—at sensor plants in the first region based on a first image or first group of images captured at a first time and depicting sensor plants in the first region at the first time; interpret a second set of pressures of the set of stressors at sensor plants in the first region based on a second image or second group of images captured at a second time—succeeding the first time—and depicting sensor plants in the first region at the second time; and interpret a third set of pressures of the set of stressors at sensor plants in the first region based on a third image or third group of images captured at a third time—succeeding the second time—and depicting sensor plants in the first region at the third time.

The system can then assemble a timeseries of pressure data—representing changes in pressures of the set of stressors in the first region during the growing cycle—including: a first time value—corresponding to the first time—linked to the first set of pressures of the set of stressors; a second time value—corresponding to the second time—linked to the second set of pressures of the set of stressors; and a third time value—corresponding to the third time—linked to the third set of pressures of the set of stressors. Based on this timeseries of pressure data, the system can then derive a set of baseline pressure curves representative of observed change in pressures of the set of stressors over time. Later, the system can leverage the set of baseline pressure curves to predict changes in pressures of the set of stressors over time. For example, the system can: derive a first baseline pressure curve, in the set of baseline pressure curves, representative of change in pressure of an insect stressor within the first region over time; derive a second baseline pressure curve, in the set of baseline pressure curves, representative of change in pressure of a fungi stressor within the first region over time; and/or derive a third baseline pressure curve, in the set of baseline pressure curves, representative of change in pressure of a soil stressor (e.g., soil pH, nitrogen level) within the first region over time.

The system can further refine this baseline pressure curve for a particular stressor—within a particular region (e.g., a particular crop, a particular geographic region) over time, such as based on additional timeseries pressure data collected for this particular stressor within the particular region.

### 5.2 Regional Pressure Map

In one implementation, the system can leverage detection of pressures of stressors at sensor plants (e.g., individual, clusters, and/or crops of sensor plants) sown within a particular region to generate a pressure map representative of abiotic and/or biotic stressors detected in this particular region during a corresponding detection period.

For example, the system can: access a first image, in a feed of satellite images (e.g., recorded by an optical sensor installed on a satellite), of a first crop of sensor plants—located in a first geographic region—and recorded during a first detection period; access a second image, in the feed of satellite images, of a second crop of sensor plants—located in the first geographic region—and recorded during the first detection period; and access a third image, in the feed of satellite images, of a third crop of sensor plants—located in the first geographic region—and recorded during the first detection period.

The system can then: interpret a first pressure of a first stressor, in a set of stressors, in the first crop of sensor plants based on optical signals (e.g., fluorescence signals) expressed by sensor plants in the first crop of sensor plants and detected in the first image; interpret a second pressure of the first stressor in the first crop of sensor plants based on optical signals expressed by sensor plants in the second crop of sensor plants and detected in the second image; and interpret a third pressure of a second stressor, in the set of stressors, in the third crop of sensor plants based on optical signals expressed by sensor plants in the third crop of sensor plants and detected in the third image. Then, at a first time succeeding the first detection period, the system can: interpret a first pressure map—representative of presence of the set of stressors in the first geographic region during the first detection period—based on the first pressure of the first stressor, the second pressure of the first stressor, and the third pressure of the third stressor.

Additionally and/or alternatively, in another implementation, the system can generate a pressure map for a particular stressor. For example, the system can: generate a first pressure map representative of presence of a first stressor, in a set of stressors, within a particular region; and generate a second pressure map representative of presence of a second stressor, in the set of stressors, within the particular region. Additionally and/or alternatively, in yet another implementation, the system can generate a pressure map for a particular crop type. For example, the system can: generate a first pressure map representative of presence of a set of stressors in crops of a first crop type (e.g., cotton) within a particular region; and generate a second pressure map representative of presence of the set of stressors in crops of a second crop type (e.g., soybean) within the particular region.

In each of these implementations, the system can repeat this process over time to generate additional pressure maps representing presence of the set of stressors in a particular region and/or in crops of a particular crop type. By repeating this process over time, the system can serve data and/or recommendations to users associated with crops in these regions, thereby enabling proactive mitigation of stressors in these crops. Further, the system can leverage timeseries of pressure data—represented in these pressure maps—to derive insights and information related to changes in pressures and/or stressors present in these regions (and/or in a particular crop) over time.

### 5.2.1 Regional Pressure Map: Interpolation

In one implementation, the system can leverage detected and/or predicted pressures of a stressor in plants in different locations (e.g., crops, agricultural fields, geographic locations) to interpolate pressures in plants and/or crops sown between these locations. In particular, in this variation, the system can interpolate between pressures of a stressor—derived for plants in a first and second subregion—to predict one or more pressures of the stressor present in plants sown in crops interposed between the first and second subregions. The system can then generate a pressure map for a geographic region—including the first subregion, the second subregion, and a sequence of regions interposed between the first and second subregions—representing predicted pressures of the stressor across the subregion, regardless of presence or absence of sensor plants in each of these subregions.

For example, the system can: interpret a first pressure of a first stressor, in a set of stressors, in a first subregion, within a geographic region, based on features extracted from a first subset of images—in a feed of images of sensor plants within the geographic region—depicting sensor plants in the first subregion during a first time period; and interpret a second pressure of the first stressor in a second subregion, within the geographic region, based on features extracted from a second subset of images—in the feed of images—depicting sensor plants in the second subregion during the first time period. Then, the system can: predict a third pressure of the first stressor at a third subregion, within the geographic region, based on the first pressure of the first stressor in the first subregion and the second pressure of the first stressor in the second subregion; and derive a first pressure map for the geographic region period based on the first pressure, the second pressure, and the third pressure. Additionally and/or alternatively, in this implementation, the system can similarly: predict a fourth pressure of the first stressor at a fourth subregion, predict a fifth pressure of the first stressor at a fifth subregion, predict a sixth pressure of the first stressor at a sixth subregion etc.; and update the first pressure map accordingly.

In one variation, the system can leverage environmental data collected for crops within the geographic region to more accurately predict pressures of stressors in subregions throughout the geographic region.

### 5.2.2 Real-time Pressure Prediction

In one implementation, the system can leverage detection of a first pressure of a particular stressor within a first region (e.g., crop, agricultural field, geographic region) to predict a second pressure of this particular stressor in a second region proximal (e.g., adjacent, bordering, nearby) the first region. For example, the system can: implement methods and techniques described above to predict a first pressure of a stressor in a first agricultural field growing crops of a first crop type; and predict a second pressure of the first stressor in a second agricultural field neighboring the first agricultural field and growing crops of the first crop type based on known and/or predicted patterns in movement, spread, growth, decay, etc. of the first stressor.

In one example, the system can: interpret a first pressure of a first stressor in a first crop—containing a set of sensor plants configured to signal pressures of the first stressor—based on features extracted from an image of the first crop captured at a first time; and leverage the first pressure of the first stressor to predict a second pressure of the first stressor, at approximately the first time, in a second crop based on known and/or derived correlations between pressures of the first stressor in the first crop and pressures of the first stressor in the second crop.

In one variation, the system can derive a pressure model linking pressures of a set of stressors in a first region (e.g., a crop, an agricultural field, a geographic region) to pressures of the set of stressors in a second region.

For example, during a first growing period, in a series of growing periods, the system can: access an image feed—captured during the first growing period—of a set of sensor plants sown in the first crop and configured to signal pressures of a set of stressors at the set of sensor plants; and interpret a first timeseries of pressure data—representing changes in pressures of the set of stressors at the set of sensor plants throughout the first growing period—based on features extracted from timestamped images in the image feed. For example, the first timeseries of pressure data can define: a first pressure of a first stressor, in the set of stressors, at a first time during the initial time period; a second pressure of the first stressor at a second time, succeeding the first time, during the initial time period; a third pressure of the first stressor at a third time, succeeding the second time, during the initial time period; etc. The first timeseries of pressure data can similarly include: a timeseries of pressures of a second stressor, in the set of stressors, throughout the initial time period; a timeseries of pressures of a third stressor, in the set of stressors, throughout the initial time period; etc.

Further, in the preceding example, the system can: prompt a user or users (e.g., a farmer, a crop owner, a crop operator) affiliated with a second crop—proximal the first crop and including no sensor plants—to manually input a second timeseries of pressure data captured for the second crop during the initial time period. For example, a farmer and/or agronomist may: record timeseries amounts of moisture in soil and/or plants for the second crop; record timeseries amounts of nitrogen uptake in plants within the second crop; record timeseries pH levels of soil within the second crop; record timeseries density and/or presence of insects and/or fungi within the second crop; etc. Upon receiving this compiled timeseries pressure data for the second crop from the user, the system can: implement regression, machine learning, deep learning, and/or other techniques to derive correlations between pressures of the set of stressors in the first crop and pressures of the set of stressors in the second crop; and store these correlations in a pressure model configured to predict pressures of the set of stressors in the second crop based on detected pressures of the set of stressors in the first crop.

5.3 Pressure Prediction: Change over Time

In one variation, the system can predict a future pressure of a stressor in plants within a particular region based on a current pressure of this stressor in plants within this particular region. In particular, in this variation, the system can: interpret a first pressure of a first stressor in a first crop—containing a set of sensor plants configured to signal pressures of the first stressor—based on features extracted from an image of the first crop captured at a first time; and predict a second pressure of the first stressor in the first crop at a second time—succeeding the first time—based on observed and/or predicted spread (e.g., dispersion or movement, growth, decay) of the first stressor within the first crop over time.

In one implementation, the system can derive a pressure model configured to predict future pressures of stressors in a particular crop and/or region based on (current) detected pressures of these stressors in this particular crop and/or region. In particular, the system can leverage timeseries of stressor data—representative of presence and/or magnitude of a set of stressors detectable in sensor plants in a particular geographic region over a particular time period—to predict current or future pressures of stressors within this particular geographic region.

For example, during a first time period, the system can: interpret a first pressure of a first stressor within a first subregion of a geographic region; interpret a second pressure of the first stressor within a second subregion of the geographic region; and interpret a third pressure of the first stressor within a third subregion of the geographic region. The system can then derive a first pressure map—representative of presence of the first stressor within the geographic region during the first time period—based on the first, second, and third pressures. Then, during a second time period, the system can: interpret a fourth pressure of the first stressor within the first subregion; interpret a fifth pressure of the first stressor within the second subregion; and interpret a sixth pressure of the first stressor within the third subregion. The system can then derive a second pressure map—representative of presence of the first stressor within the geographic region during the second time period—based on the fourth, fifth, and sixth pressures. The system can then leverage the first and second pressure map to derive a pressure model configured to predict changes in pressures of the first stressor in this geographic region as a function of time.

Therefore, in the preceding example, during a third time period succeeding the second time period, the system can: derive a third pressure map—representative of presence of the first stressor within the geographic region during the third time period—based on detected pressures of the first stressor in the first, second, and/or third subregions; access the pressure model; and predict a fourth pressure map—representative of presence of the first stressor within the geographic region during a fourth time period succeeding the third time period—based on the third pressure map and the pressure model.

Further, in another implementation, the system can additionally access timeseries environmental data for a particular crop and/or region—such as timeseries weather data and/or timeseries treatment data (e.g., crop treatment data)—corresponding to timeseries of stressor data. In this implementation, the system can fuse this timeseries environmental data with timeseries stressor data to derive a pressure model configured to predict future pressures of stressors and/or changes in pressures of stressors in a particular crop and/or region as a function of detected pressures of stressors and/or environmental data (e.g., current crop treatments, weather, crop management information) for this particular crop and/or region.

The system can therefore derive correlations between stressor data (e.g., pressures of stressors recorded over time) and environmental data recorded for a particular crop and/or region to: identify stressor treatments best matched to this particular crop and/or region; and predict changes in pressures of stressors in this particular crop and/or region based on detected pressures of stressors and/or recorded environmental data. Therefore, by tracking historical stressor data for this particular region or crop over time (e.g., over a month, over a crop season, over multiple crop seasons), the system can derive correlations configured to predict future pressures of stressors in this particular region or crop, thereby enabling users (e.g., farmer, agronomist, field worker) associated with the crop to rapidly implement techniques configured to mitigate and/or prevent pressures of these stressors and therefore increase crop yield and/or reduce costs associated with treatment of stressors in the crop and/or crop loss.

### 5.3.1 Environmental Data: Conditions for Spread

In one variation, the system can leverage timeseries environmental data recorded for a particular region (e.g., a crop, an agricultural field, a geographic region) to predict current and/or future pressures of stressors within this particular region.

In one implementation, the system can predict changes in pressures of a particular stressor over time based on timeseries environmental data. In particular, the system can: predict a first pressure of a first stressor present in plants sown within a region of a crop based on a first image of sensor plants within this region captured at a first time; access a first timeseries of environmental data—such as including weather data, treatment data, observed stressor data, etc.—corresponding to environmental conditions within the region of the crop during a first time period including the first time; and, based on the first pressure and the first timeseries of environmental data, predict a second pressure of the first stressor at a future time. In particular, the system can leverage known and/or derived correlations between environmental data and changes in pressures of the first stressor over time to predict the second pressure of the first stressor at the future time.

Further, in the preceding implementation, the system can leverage detected pressures of a particular stressor in a first region to predict pressures of this particular stressor in a second region (e.g., proximal the first region) based on environmental data recorded for each of these regions.

Additionally or alternatively, in another implementation, the system can leverage known characteristics of a particular stressor or stressors to predict changes in pressures of the particular stressor over time. For example, at a first time during a growing period for crops within a particular region, the system can: predict a first pressure of a fungi stressor at a first subregion within this particular region; and predict a second pressure of the fungi stressor at a second subregion within this particular region. The system can then: access a set of spread conditions defined for the fungi stressor—such as a minimum and/or maximum temperature (e.g., air temperature), a minimum and/or maximum amount of rainfall, a minimum and/or maximum amount of sun exposure, a set of soil conditions (e.g., nitrogen level, pH level), maturity of plants in this particular region, etc.—and defining conditions required for transmission of the fungi stressor between plants in the particular region. The system can then: access a timeseries of environmental data—including timeseries conditions (e.g., weather, treatments) at plants in the particular region—captured for the particular region during a time period including the first time; characterize a correlation between the set of spread conditions and the timeseries of environmental data; and, in response to the correlation exceeding a threshold correlation, predict spread of the fungi stressor—such as at a first rate and/or according to a first pattern or distribution—within the particular region. Based on this predicted spread, the system can thus predict: a third pressure of the fungi stressor at the first subregion at a second time succeeding the first time; and a fourth pressure of the fungi stressor at the second subregion at the second time.

### 5.4 Yield Prediction

In one implementation, the system can predict yield for a particular crop type (e.g., soybean, tomato, cotton, lettuce) within a particular geographic region and/or for a particular crop.

Generally, the system can predict yield for crops of a particular crop type based on pressures of stressors present in these crops. In particular, the system can: leverage images of crops within a geographic region to detect optical signals expressed by sensor plants present in these crops; predict pressures of a set of stressors throughout the geographic region based on the detected optical signals; derive a pressure map—representative of magnitude and/or distribution of pressures of the set of stressors throughout the geographic region—based on predicted pressures of the set of stressors; and predict a crop yield for a particular crop type within the geographic region based on the derived pressure map.

For example, the system can: predict a first pressure of a first stressor in a first crop—including a first set of sensor plants configured to signal presence of the first stressor—of a first crop type within a geographic region; predict a second pressure of the first stressor in a second crop—including a second set of sensor plants configured to signal presence of the first stressor—of the first crop type within the geographic region; predict a third pressure of the first stressor in a third crop—including a third set of sensor plants configured to signal presence of the first stressor—of the first crop type within the geographic region; and derive a pressure map—representing pressures of the first stressor throughout the geographic region—based on the first, second, and third pressures. The system can then predict a crop yield for crops of the first crop type in the geographic region based on this pressure map. The system can then repeat this process to similarly predict a crop yield for each crop type, in the set of crop types, present in the geographic region.

In one variation, the system can leverage environmental data—including weather data, treatment data, and/or observed stressor data—recorded for the geographic region in combination with a pressure map to predict crop yield. For example, the system can: derive a pressure map representative of conditions—such as soil conditions (e.g., soil pH, nitrogen content), insect or fungi presence, disease, drought or flood, etc.—across a geographic region including a set of crops of a first crop type; access timeseries environmental data recorded for the geographic region during the growth period; access timeseries treatment data—such as type and/or dosages (e.g., amounts, duration) of treatments (e.g., insecticide, fungicide, water, soil pH adjustor, fertilizer) applied to a crop or crops—recorded for the geographic region during the growth period; and predict a crop yield for the first crop type within the geographic region based on the pressure map and the timeseries environmental data.

### 5.4.1 Yield Model

In one implementation, the system can leverage a yield model to predict yield for a particular crop type (e.g., cotton, soybean, corn) in a particular crop, in a particular region, and/or globally. The system can then selectively distribute insights, instructions and/or suggestions to various users associated with various divisions of an agricultural supply chain based on the predicted yield for this particular crop type.

In this implementation, the system can derive a yield model configured to predict crop yield for a particular crop, a particular region, and/or a particular crop type within the particular region. In particular, the system can: record a timeseries of pressure data representing pressures of the set of stressors within a region (e.g., a crop, a geographic region) throughout an initial growing period; record a final crop yield for crops of a crop type (e.g., soybean, cotton, lettuce, tomato) within this region, such as recorded during and/or after harvesting of crops of the crop type at an end of the initial growing period; store the timeseries of pressure data and the final crop yield in a first growing period packet (e.g., a data packet); and, based on the timeseries of pressure data and the final crop yield, derive a yield model linking pressures of the set of stressors within the geographic region to crop yield for crops of the crop type within the geographic region.

The system can further repeat this process during subsequent growing periods for crops of the crop type within the geographic region to further refine the yield model. In particular, the system can: generate a series of growing periods, such as including the first growing period packet, a second growing period packet generated for a second growing period, a third growing period packet generated for a third growing period, etc.; and rectify the yield model based on each growing period packet in the series of growing period packets generated for crops of the crop type in this particular region. Furthermore, the system can execute this process to derive a yield model for crops of each crop type present in the region. For example, the system can: derive a first crop yield model configured to predict crop yield for tomato crops within the region; derive a second crop yield model configured to predict crop yield for soybean crops within the region; derive a third crop yield model configured to predict crop yield for cotton crops within the region; etc.

For example, the system can: access a first timeseries of pressure data representing changes in pressures of a set of stressors in a first region during a first growing period; access a first crop yield for crops of a first crop type (e.g., cotton) in the first region during a first harvest period corresponding to the first growing period; access a second timeseries of pressure data representing changes in pressures of the set of stressors in the first region during a second growing period succeeding the first harvest period; access a second crop yield for crops of the first crop type (e.g., cotton) in the first region during a second harvest period corresponding to the second growing period. The system can then implement regression, machine learning, deep learning, and/or other techniques to derive correlations between pressures of stressors and crop yield in this particular region and/or in a particular crop in this region.

### 5.5 Yield Profile

In one variation, the system can derive a yield profile representing predicted yield for crops of a set of crop types (e.g., soybean, tomato, cabbage, corn, cotton) within a particular region.

In particular, in this variation, the system can: implement methods and techniques described above to interpret pressures of a set of stressors in various subregions within a particular region and derive a pressure map for the particular region accordingly; predict a crop yield, in a set of crop yields, for each crop type, in the set of crop types, based on the pressure map; and compile the set of crop yields into a yield profile—defining predicted crop yield for each crop type in the set of crop types—for the particular region. Over time, the system can update the yield profile based on detected and/or predicted changes in pressures of the set of stressors throughout the geographic region.

For example, during a growing period, the system can: access a first set of images captured during a first time period, within the growing period, depicting sensor plants sown in crops within a first geographic region; interpret pressures of a set of stressors within the geographic region based on features extracted from the first set of images; and assemble a first pressure map depicting pressures of the set of stressors within the first geographic region during the first time period accordingly. The system can then: predict a first crop yield, in a first set of crop yields, for crops of a first crop type (e.g., soybean) based on a first subset of features extracted from regions of the first pressure map corresponding to crops of the first crop type; generate a first yield profile, in a set of yield profiles, for the first geographic region, representing predicted yields for crops of the set of crop types during the first time period; and store the first crop yield—linked to the first crop type—in the first yield profile.

The system can further: predict a second crop yield, in the first set of crop yields, for crops of a second crop type (e.g., tomato) based on a second subset of features extracted from regions of the first pressure map corresponding to crops of the second crop type; store the second crop yield—linked to the second crop type—in the first yield profile; and repeat this process for each crop type, in the set of crop types, to assemble a comprehensive yield profile for the first geographic region during the first time period.

Later, during the growing period, the system can: access a second set of images captured during a second time period succeeding the first time period, within the growing period, depicting sensor plants sown in crops within the first geographic region; interpret pressures of the set of stressors within the geographic region based on features extracted from the second set of images; assemble a second pressure map depicting pressures of the set of stressors within the first geographic region during the first time period accordingly; predict a crop yield, in a second set of crop yields, for crops of each crop type, in the set of crop types based on features extracted from regions of the second pressure map corresponding to crops of each crop type; and generate a second yield profile, in the set of yield profiles, for the first geographic region, representing predicted yields for crops of the set of crop types during the second time period.

The system can then: store the second set of crop yields—each linked to a particular crop type—in the second yield profile; link the first yield profile to a first time value (e.g., a timestamp) corresponding to the first time period; link the second yield profile to a second time value corresponding to the second time period; and thus derive a timeseries of crop yield profiles—including the first yield profile linked to a first time value (e.g., a timestamp), corresponding to the first time period, and the second yield profile linked to a second time value corresponding to the second time period—for the first geographic region. The system can repeat this process throughout a remainder of the growing season—and for each subsequent growing season—to derive a comprehensive timeseries of crop yield profiles for the first geographic region.

### 5.6 Crop Health

In one implementation, the system can leverage timeseries of crop data (e.g., pressure, stressor, and/or environmental data) collected for a particular crop and/or a particular region to characterize health (hereinafter “crop health”) of this particular crop and/or particular region.

For example, the system can access a first set of crop data—corresponding to operation of a first crop, located in a first region, during a first time period—including: a quantity of stressors detected during the first time period; an average pressure of each stressor detected; a resilience of the crop (e.g., an average duration to recovery) to each stressor detected; a total yield of the crop during a harvest season corresponding to the first time period; and/or a quality—such as assessed by users associated with the crop during the harvest season—of the crop harvested; etc. The system can then characterize a health score (e.g., a percentage between 0 percent and 99 percent, a value on a scale from one to ten, categorized as “poor,” “fair,” “good,” or “excellent”) for the crop based on the first set of crop data collected during the first time period.

In the preceding example, the system can repeat this process for multiple crops and/or regions of crops to assemble a health map representative of crop health in various regions and/or across these regions during a particular time period. Further, the system can update this health map over time, such as over multiple growing periods.

In one variation, the system can predict crop yield for crops of a crop type within a particular region based on predicted crop health of crops of the crop type within this particular region. In particular, in this variation, the system can: characterize plant health for crops of a crop type within a region based on a set of crop data—such as including timeseries pressure data and/or environmental data (e.g., treatment data, weather data)—collected for crops of the crop type in this region (e.g., during a current growing season); access a yield model linking plant health to crop yield for crops of the crop type; and predict a crop yield for crops of the crop type (e.g., at an end of the current growing season) based on plant health of crops of the crop type in the region and the yield model.

For example, at a first time during a growing period, the system can: access a first timeseries of crop data—including a first timeseries of pressure data and a first timeseries of environmental data—recorded for crops of a first crop type, in a set of crop types, sown in a first subregion in the region during a first time period preceding the first time; access a second timeseries of crop data—including a second timeseries of pressure data and a second timeseries of environmental data—recorded for plants of the first crop type sown in a second subregion in the region during the first time period; and access a third timeseries of crop data—including a third timeseries of pressure data and a third timeseries of environmental data—recorded for plants of the first crop type sown in a third subregion in the region during the first time period. The system can then: predict a first health score, in a set of health scores, for crops of the first crop type in the first subregion based on the first timeseries of crop data; predict a second health score, in the set of health scores, for crops of the first crop type in the second subregion based on the second timeseries of crop data; predict a third health score, in the set of health scores, for crops of the first crop type in the third subregion based on the third timeseries of crop data; and predict a first crop yield for crops of the first crop type—such as at a future time succeeding the first time (e.g., at an end of the growing period)—based on the yield model and the set of health scores.

### 5.7 Prompts

In one implementation, the system can selectively generate and distribute prompts related to detection and mitigation of pressures of stressors within the crop or within the particular region. In particular, the system can identify and suggest pressure mitigation techniques configured to: reduce pressures of stressors detected in a crop or region; minimize spread of detected pressures within a crop or across a particular region; and maximize crop yield within a particular crop and/or across a particular region.

For example, the system can derive a first pressure map—representative of locations of various pressures of stressors detected during a first time period—for a particular region, as described above. The system can then: predict a second pressure map—representative of predicted locations of predicted pressures of stressors detected during a second time period succeeding the first time period—based on the first pressure map and a pressure model generated for this particular region; and/or estimate a predicted crop yield for crops of a first crop type in the particular region based on the first pressure map, the second pressure map, and a yield model linking pressure maps to crop yield for crops of the first crop type in the particular region.

The system can then transmit a set of prompts to execute a set of mitigation techniques—configured to increase efficiency of crop treatments and maintenance over time and/or maintain or increase yield of crops—to a set of crop operators associated with crops in the particular region based on the first pressure map. Further, the system can update a crop profile associated with crops in the particular region based on the first pressure map, the second predicted pressure map, and the predicted crop yield. The system can then transmit this data to additional end users (e.g., a crop treatment developer, a clothing retailer, a food retailer) associated with and/or interested in yield and/or health of crops in this particular region.

### 5.7.1 Treatment Efficacy

In one implementation, the system can characterize effectiveness of crop treatments based on detected changes in pressures of a particular stressor or stressors.

For example, the system can: interpret a first pressure of a first stressor in a crop of a particular crop type based on features extracted from a first image of the crop recorded during a first time period; and, in response to interpreting the first pressure of the first stressor, generate a prompt to apply a first treatment—such as a particular dosage and/or type of treatment (e.g., pesticide, fungicide, irrigation, fertilizer, soil pH treatment)—to the crop during a second time period succeeding the first time period, and transmit the prompt to a user (e.g., a farmer) associated with the crop. The system can then: interpret a second pressure of the first stressor in the crop based on features extracted from a second image of the crop recorded during a third time period succeeding the second time period; characterize a difference between the first pressure and the second pressure of the first stressor; and characterize efficacy of the first treatment in mitigating pressures of the first stressor based on the difference.

For example, in response to the difference exceeding a threshold difference—such that the detected pressure of the first stressor decreased (e.g., by more than a threshold amount) responsive to application of the first treatment—the system can characterize the first treatment as highly effective in mitigating pressures of the first stressor. However, in response to the difference falling below a threshold difference—such that the detected pressure of the first stressor increased and/or exhibited minimal reduction (e.g., by less than a threshold amount) responsive to application of the first treatment—the system can characterize the first treatment as ineffective in mitigating pressures of the first stressor. The system can store this information in the crop profile for this crop to inform future suggestion of treatments for the first stressor in this particular crop, in crops of the crop type, and/or for crops of all crop types.

### 5.8 Supply Chain Tracking

In one implementation, the system can track distribution of a population of sensor plants—modified to include a particular identifier—throughout a life cycle (e.g., along a crop supply chain) of these sensor plants, such as from a growing period within a crop, to loading on a particular delivery vehicle, to storage within a particular storage facility, to processing within a particular facility, etc.—during transfer of the sensor plant through a crop supply chain.

For example, for a first sensor plant—including a fluorescent tag configured to express a baseline fluorescence signal—the system can: access a first image (e.g., a hyperspectral image), in a set of images, captured by a farmer or agronomist (e.g., via a mobile device) associated with a crop containing the sensor plant, including a first timestamp, and depicting the baseline fluorescence signal; access a second image, in the set of images, captured by an optical sensor arranged within a crop storage facility, including a second timestamp and a batch identifier for a batch containing the sensor plant, and depicting the baseline fluorescence signal; access a third image, in the set of images, captured by an optical sensor installed within a processing and/or manufacturing facility (e.g., a food manufacturing and/or processing facility, a clothing manufacturing facility), including a third timestamp, and depicting the baseline fluorescence signal; and, access a fourth image, in the set of images, captured by an optical sensor installed within a retail facility (e.g., a grocery store, a clothing store), including a fourth timestamp, and depicting the baseline fluorescence signal. The system can thus link the sensor plant (e.g., a product of the sensor plant) sold in the retail facility to the crop and/or region of origin based on detection of the baseline fluorescence signal in the set of images.

Over time, based on these linkages, the system can access additional information regarding crop outputs and crop distribution, and thus update a crop profile for a particular crop and/or for a particular region of crops based on this information. The system can then leverage this information to derive more precise insights or information related to crop yield, crop supply, crop health, crop quality, and/or crop management for a particular crop and/or region of crops. For example, a crop of soybean plants (e.g., sensor soybean plants) can be modified to express a baseline fluorescence signal configured to fluoresce only in the soybean pods, thereby enabling direct reporting of soybean yield, by the crop of soybean plants, throughout a life cycle of these soybean plants, such as during growth, harvesting, and/or distribution across the supply chain). In particular, the system can access images of soybean plants sown in and/or harvested from this crop; characterize a magnitude (e.g., intensity) of the baseline fluorescent signal detected in these images; and estimate yield of the soybean crop based on the magnitude of this baseline fluorescent signal. The system can then repeat this process to update yield estimates for this soybean crop over time.

Further, in this implementation the system can leverage this information to: identify subsets of users associated with the supply chain for a particular crop and/or region of crops; and, over time, selectively transmit information, insights, instructions, recommendations and/or suggestions—such as related to actual and/or predicted crop yield, crop supply, crop health, crop quality, crop management, etc.—to these different subsets of users.

For example, the system can identify a subset of users associated with manufacturing clothing from cotton grown in a particular region based on receiving identification of a baseline fluorescence signal—linked to cotton grown in the particular region—in cotton stored at a manufacturing plant associated with the subset of users. Then, during a next growing period for cotton in this particular region, the system can selectively serve notifications and/or prompts to this subset of users, such as: in response to detecting a large pressure of a particular stressor in this region; in response to predicting a very low crop supply for cotton in the particular region; in response to predicting a very high crop supply for cotton in this particular region; etc. The system can then therefore supply valuable insights or information to this subset of users in (near) real-time regarding derived data and/or predictions related to cotton supply for this particular subset of users and from this particular region during this growing period.

In one variation, the system can leverage detection of this baseline signal to distinguish between plants (e.g., sensor plants) in a crop and weeds growing in the crop. For example, the system can: access an image of crop—including a set of sensor plants configured to express a baseline fluorescence signal—recorded by an optical sensor (e.g., installed on manned or unmanned field equipment such as a tractor, on a handheld device operated by a farmer or agronomist, and/or on a boom or pole installed in the field); isolate regions of the image corresponding to absence of the baseline fluorescence signal; and flag these regions for application of a particular weed treatment—such as by alerting a farmer to apply this particular weed treatment and/or by triggering application of the weed treatment by automated field equipment (e.g., an automated sprayer installed on a tractor)—and/or for further investigation. The system can regularly (e.g., daily, weekly) repeat this process to investigate weeds and/or other threats (e.g., invasive plants) present in the crop, thereby reducing risk for this crop and enabling increased yield.

### 6. Modeling Plant Health

In one implementation, the system can leverage sensor plant data collected over time from a particular sensor plant or group of sensor plants—grown within a particular crop—to characterize plant health of individual plants, groups of plants, and/or all plants in the particular crop.

In particular, in this implementation, the system can converge on a particular set of conditions (e.g., environmental conditions)—such as presence of a set of stressors (e.g., abiotic and/or biotic stressors), soil conditions (e.g., pH levels, nitrogen levels), weather conditions, etc.—that are indicative of plant health for plants in this particular crop, such for an individual sensor plant or a group of sensor plants within the particular crop and/or an entire crop of sensor plants. The system can therefore: detect signals (e.g., fluorescence signals) expressed by the set of sensor plants in this particular crop; predict a current set of conditions at the set of sensor plants based on these signals; and interpret plant health—such as an individual plant health for each sensor plant, in the set of sensor plants, and/or a composite plant health for the set of sensor plants—based on the current set of conditions detected at the set of sensor plants.

Based on the predicted plant health, the system can select a particular crop treatment—tailored to a particular plant or group of plants within the crop—configured to improve or maintain plant health.

Therefore, in this implementation, the system can leverage sensor plant data collected over time for one or more sensor plants sown in a particular crop to predict conditions at plants throughout this particular crop—such as corresponding to magnitude and/or distribution plant stressors (e.g., soil pH levels, nitrogen uptake, water retention, insect presence, fungi presence)—and thus characterize health of individual plants or groups of plants at high-resolution, thereby enabling tailored treatment of particular groups of plants in this crop responsive to changes in plant health.

### 6.1 Target Conditions

In one implementation, the system can define a target set of plant conditions (e.g., soil pH, nitrogen levels in soil, irrigation levels, fertilizer levels, fungicide levels) for a particular crop. Generally, in this implementation, the system can: derive a target set of plant conditions that yields at least a target crop health, such as corresponding to a threshold crop yield (e.g., a minimum crop yield); and store these target set of plant conditions as constituting a “healthy crop” or “healthy plant” (e.g., in the crop profile generated for this particular crop).

In particular, in this implementation, during an initial time period, the system can: track plant conditions—such as a magnitude of an insect pressure, a magnitude of a fungi pressure, a magnitude of a drought pressure (e.g., dehydration), a plant nitrogen amount (e.g., an amount of nitrogen consumed by plants from the soil), etc.—in sensor plants located within the crop; and analyze these data to derive a correlation between plant conditions and plant health. Accordingly, the system can: derive a target set of plant conditions for plants in the crop that yield at least a minimum or target plant health; specify that a sensor plant signaling plant conditions—such as by outputting a set of fluorescence signals in particular wavelength ranges linked to these plant conditions—approximating (e.g., within a threshold deviation of) the target set of plant conditions qualify as “healthy” plants; and during a growing season, implement this target set of plant conditions to selectively distinguish between “healthy” plants in the crop and “unhealthy” or “less healthy” plants in the crop which may contribute to crop loss (e.g., decreased crop yield) if left untreated.

In one example of the foregoing implementation, the system can: track a timeseries of plant conditions—such as including pressure data, soil data, weather data, etc.—for sensor plants growing within a crop over an initial time period; access timeseries crop data—such as including plant health data (e.g., observed growth, wilting, plant death, color changes, fruit growth) and/or yield data—recorded for plants in the crop during the initial time period; calculate a correlation between plant conditions and plant health for sensor plants in the particular crop based on the timeseries of plant conditions and timeseries crop data; and define a target set of plant conditions associated with a threshold plant health—such as associated with a threshold probability of achieving a threshold crop yield—based on this correlation. More specifically, in this example, the system can implement machine learning, artificial intelligence, a neural network, or other analysis techniques to characterize plant health as a function of plant conditions based on detected plant conditions and observed health data for sensor plants in this particular crop. Based on a target or threshold health score (e.g., minimum health score) defined for plants in the particular crop—such as predicted to achieve a threshold crop yield—such as specified for the advertising campaign by an ad publisher—the system can derive a target set of conditions predicted to yield this threshold health score for plants in the crop.

### 6.1.1 Example: Nitrogen Amounts in Soil

In one example, the system can define a target nitrogen amount for plants in a particular crop. In particular, in this example, the crop (e.g., a soybean crop, a corn crop, a cotton crop) can include a set of sensor plants—such as planted in clusters in various regions of the crop and/or across the entire field, such that the set of sensor plants includes each plant in the crop—configured to signal soil conditions at the set of sensor plants. In particular, in this example, each sensor plant, in the set of sensor plants can include: a promoter linked to nitrogen presence at plants; a reporter (e.g., a fluorescent protein)—linked to the promoter—configured to express a fluorescence signal representing nitrogen uptake by the sensor plant. In this example, the system can therefore: detect this fluorescence signal—such as in images of sensor plants recorded by a satellite—and interpret amounts of nitrogen consumed by sensor plants based on an intensity of the fluorescence signal.

During a first growing season for this particular crop, the system can leverage a global target nitrogen amount—such as a generic nitrogen amount defined for all plants generally or all plants of a particular crop type (e.g., soybean, corn, cotton)—to predict plant health throughout the first growing season. In particular, the system can: access a feed of images—such as recorded by a satellite—of the crop; detect fluorescence signals expressed by the set of sensor plants in the crop and depicted in images in the feed of images; interpret amounts of Nitrogen absorbed by sensor plants, in the set of sensor plants, based on these fluorescence signals; and characterize plant health—such as across the crop and/or in particular subregions of the crop—based on amounts of nitrogen absorbed by sensor plants in the crop and the global target nitrogen amount.

Over time, as the system collects additional data for sensor plants in this crop—such as including timeseries of nitrogen amounts, timeseries nitrogen treatment data (e.g., frequency and amounts of nitrogen applied to soil), plant health data, and/or crop yield data—the system can converge on a target nitrogen amount that is crop-specific and/or plant-specific, such as by updating the generic nitrogen amount based on this additional data collected over time. For example, during the first growing season, the system can collect surveys completed by users associated with the crop—such as at various times throughout the first growing season—and indicative of plant health for plants throughout the crop, such as specifying visual characteristics of plants in the crop (e.g., color, wilting, height, size of fruit, growth of fruit), treatments applied to the crop (e.g., nitrogen, pesticide, fungicide, irrigation), crop loss, crop yield, etc. Based on this data—in combination with detected amounts of nitrogen in sensor plants throughout the crop—the system can converge on a target amount of nitrogen corresponding to this particular crop and/or to a particular subregion of this crop. Over time, as the system continues to collect additional data for this crop, the system can continue to refine this target amount of nitrogen, such that a user or users associated with the crop may apply nitrogen to the soil—at particular times of the growing season and/or in particular subregions of the crop—according to the target amount of nitrogen defined for this particular crop and/or subregion of the crop and configured to yield healthy plants in this crop.

Further, during this first growing season, the system can: access applied amounts of nitrogen—such as applied to soil across the crop and/or particular subregions of the crop—specified by a user (e.g., a farmer, an agronomist) associated with the crop; and characterize a nitrogen uptake of plants in the crop—such as for plants in a particular subregion of the crop and/or for all plants generally across the crop—based on a difference between the applied amounts of nitrogen and amounts of nitrogen detected (e.g., based on fluorescence signals expressed by sensor plants) at sensor plants in the crop.

For example, the system can access an initial applied amount of nitrogen applied to soil in a crop at an initial time corresponding to a start of the growing season. Then, at a first time, the system can: access a first image of the crop recorded by a satellite; detect a first fluorescence signal expressed by sensor plants in a first subregion of the crop; detect a second fluorescence signal expressed by sensor plants in a second subregions of the crop; interpret a first amount of nitrogen consumed by plants (e.g., from the soil) in the first subregion based on the first fluorescence signal; and interpret a second amount of nitrogen consumed by plants in the second subregion based on the second fluorescence signal. Then, for the first subregion, the system can: calculate a first ratio of the first amount of nitrogen to the initial applied amount of nitrogen; calculate a duration between the first time and the initial time; and characterize a first nitrogen uptake (e.g., a rate of nitrogen consumption) based on the first ratio and the duration. Similarly, for the second subregion, the system can: calculate a second ratio of the second amount of nitrogen to the initial applied amount of nitrogen; and characterize a second nitrogen uptake (e.g., a rate of nitrogen consumption) based on the second ratio and the duration. Therefore, prior to subsequent application of nitrogen in soil in the crop, the system can: derive a first applied amount of nitrogen—predicted to yield a nitrogen uptake corresponding to the target nitrogen amount in plants in the first subregion—for the first subregion of the crop; derive a second applied amount of nitrogen—predicted to yield a nitrogen uptake corresponding to the target nitrogen amount in plants in the second subregion—for the second subregion of the crop; generate a prompt to apply the first and second applied amount of nitrogen in the first and second subregions, respectively, at a second time (e.g., during the first growing season); and transmit the prompt to a user or a group of users associated with the crop.

### 6.2 Characterizing Plant Health

The system can characterize plant health in a particular crop based on the target set of plant conditions defined for this crop.

In particular, in this implementation, the system can characterize plant health based on a difference between a current set of plant conditions for the crop—such as derived from fluorescence signals expressed by sensor plants in the crop and detected in images of the crop—and the target set of plant conditions defined for the crop.

For example, a crop can include sensor plants configured to signal nitrogen uptake in these sensor plants (e.g., in the crop). In particular, each sensor plant, in a set of sensor plants located in the crop, can be configured to output a fluorescence signal—within a target wavelength range—representing an amount of nitrogen consumed by the sensor plant (e.g., from the soil). In this example, during a first time period, the system can: derive a target nitrogen amount for soil in a crop—such as a target nitrogen dosage defining a frequency of nitrogen application and a quantity of nitrogen applied per application—configured to yield plants “healthy” plants in this particular crop, such as characterized by a health score exceeding a threshold health score; and store this target nitrogen amount in a crop profile generated for the crop.

Then, during a second time period succeeding the first time period, the system can: access a feed of images of sensor plants in the crop recorded during the second time period by an imaging system (e.g., a satellite, an optical sensor installed on a drone, a tractor, or a pole installed in the crop, or a camera on a mobile device) configured to capture fluorescence signals output by sensor plants—configured to output fluorescence signals within a target wavelength responsive to various plant stressors; extract a first intensity of a fluorescence signal (e.g., a composite fluorescence signal output by the set of sensor plants) within the target wavelength range; and predict a current nitrogen level in plants in the crop based on the first intensity of the fluorescence signal.

In the preceding example, the system can then: access the target nitrogen amount—stored in the crop profile—defined for this particular crop; characterize a difference between the current nitrogen amount and the target nitrogen amount; and characterize health of plants (or “plant health”) in the crop based on the difference. For example, the system can estimate a health score for plants in the crop, such as represented by a percentage between 0% and 100%, a score between zero and ten, a rating of poor, moderate, good or excellent health, etc. In one example, in response to the difference exceeding an upper threshold difference defined for plants in this particular crop, the system can estimate a relatively low health score (e.g., “5%”, “ 1/10”, poor health) for plants in the crop. Alternatively, in response to the difference falling below the upper threshold difference and exceeding a lower threshold difference, the system can estimate a relatively moderate health score (e.g., “50%”, 5/10, moderate health) for plants in the crop. Alternatively, in response to the difference falling below the lower threshold difference, the system can estimate a relatively high health score (e.g., “95%”, 9/10, excellent health) for plants in the crop.

### 6.2.1 Health Model

In one variation, the system can derive a plant health model configured to intake a set of current conditions detected for a particular sensor plant or group of sensor plants and output a prediction of current plant health for this particular sensor plant or group of sensor plants.

For example, during a first growing season for a particular crop, the system can: track a first set of plant conditions at a first set of sensor plants located in a first subregion of the crop; track a second set of plant conditions at a second set of sensor plants located in a second subregion of the crop; access a first set of plant surveys—completed by a user or users associated with the crop—indicating health of plants in the first subregion throughout the first growing season; access a second set of surveys—completed by the user or users associated with the crop—indicating health of plants in the second subregion throughout the first growing season; and/or access a first set of crop data collected for the crop during the first growing season, such as including weather data, crop yield data (e.g., for the whole crop and/or for subregions of the crop), crop treatment data (e.g., for the whole crop and/or for subregions of the crop), etc.;

Then, the system can: derive a first health model—based on the first set of plant conditions, the first set of plant surveys, and the first set of crop data—configured to predict health of plants in the first subregion of the crop based on plant conditions at sensor plants in the first subregion; and derive a first health model—based on the second set of plant conditions, the second set of plant surveys, and the first set of crop data—configured to predict health of plants in the first subregion of the crop based on plant conditions at sensor plants in the first subregion.

Then, during a subsequent growing season, the system can: access a first image depicting plants in the first subregion of the crop; interpret a first set of plant conditions based on fluorescence signals extracted from the first image; and characterize health of plants in the first subregion—such as represented by a first plant health score—based on the first set of plant conditions and the first health model. Further, the system can: access a second image depicting plants in the second subregion of the crop; interpret a second set of plant conditions based on fluorescence signals extracted from the second image; and characterize health of plants in the second subregion—such as represented by a second plant health score—based on the second set of plant conditions and the second health model. In this example, the system can then select a particular treatment pathway for implementation in each subregion of the crop, thereby enabling tailored treatment of plants in each subregion based on changes in health of plants in these subregions.

In one example, the system can derive a health model configured to output a health score—representing health of plants in a particular subregion of the crop—based on a magnitude of nitrogen consumption detected in sensor plants in the particular subregion, a magnitude of water consumption detected in sensor plants in the particular subregion, a magnitude of a fungi pressure detected in the particular subregion, and/or a magnitude of an insect pressure detected in the particular subregion.

### 6.3 Target Treatment

The system can leverage differences between the target set of conditions defined for the crop and (current) detected conditions in this crop to suggest implementation of targeted treatments for plants in this crop.

In particular, the system can selectively suggest treatments—such as to a farmer or agronomist associated with the crop—configured to shift current conditions within the crop toward the target set of conditions defined for the crop and/or for a particular subset of plants (e.g., in a particular subregion) in this crop.

Therefore, the system can: access an image or images of sensor plants in the crop; leverage a reporter model defined for these sensor plants to extract a fluorescence signal representing a first condition of these sensor plants, such as a magnitude of a fungi stressor present at these sensor plants or an amount of nitrogen consumed by sensor plants; access a target condition—such as a threshold magnitude (e.g., a maximum magnitude) of the fungi stressor tolerable by plants in the crop or a target amount of nitrogen (e.g., within a target range) configured to maximize plant health or growth—defined for plants in the crop and corresponding to the first condition; characterize a difference between the first condition and the target condition; and based on the difference, select a treatment pathway for plants in the crop configured to regulate the first condition toward the target condition. The system can then prompt a user associated with the crop to implement this treatment pathway and/or automatically trigger implementation of the treatment pathway, such as via an automated treatment system.

Further, by leveraging signals generated by sensor plants distributed throughout a crop, the system can selectively suggest different treatment types and/or dosages of treatments in different regions within this particular crop. The system can therefore enable targeted treatment of plants within a particular crop and/or geographic region (e.g., spanning multiple crops) based on conditions within each of these different regions.

For example, the system can: access a feed of images of a population of sensor plants including a first set of sensor plants sown in a first subregion of a crop and a second set of sensor plants arranged in a second subregion of the crop; interpret a first set of conditions at plants in the first subregion based on a first subset of features—such as fluorescence intensities within a first wavelength range—extracted from a first image in the image feed; access a set of target conditions defined for plants in the crop; characterize a first difference between the first set of conditions and the target set of conditions; and, in response to the first difference exceeding a threshold difference, select a first treatment pathway for application in plants in the first subregion. The system can further: interpret a second set of conditions at plants in the second subregion based on a second subset of features—such as fluorescence intensities within the first wavelength range—extracted from the first image; characterize a second difference between the second set of conditions and the target set of conditions; and, in response to the second difference exceeding the threshold difference, select a second treatment pathway for application in plants in the second subregion. The system can then: generate a notification including a prompt to implement the first treatment pathway in the first subregion and implement the second treatment pathway in the second subregion; and transmit the prompt to a farmer affiliated with the crop.

### 6.3.1 Treatment Map

In one variation, the system can derive a treatment map for a particular crop based on the target set of conditions defined for the crop. In particular, in this variation, the system can assemble a treatment map—specifying a location and a magnitude (e.g., frequency and/or amount) of application for each treatment pathway selected for the crop—based on the treatment pathways selected for various subregions of the crop.

For example, the system can: access an image—recorded by a satellite at a first time—of a crop and depicting a set of fluorescence signals expressed by sensor plants in the crop; interpret a first nitrogen amount in plants in a first subregion of the crop based on a first fluorescence signal in the set of fluorescence signals; interpret a second nitrogen amount in plants in a second subregion of the crop based on a second fluorescence signal in the set of fluorescence signals; and interpret a third nitrogen amount in plants in a third subregion of the crop based on a third fluorescence signal in the set of fluorescence signals. Then, for the first subregion of the crop, the system can: access a first target nitrogen amount—in a set of target nitrogen amounts derived for the crop—corresponding to plants in the first subregion; characterize a difference between the first nitrogen amount and the first target nitrogen amount; and derive a first applied nitrogen amount—for applying to soil in the first subregion at a second time succeeding the first time—based on the difference. The system can similarly repeat this process for the second and third subregions to derive a second applied nitrogen amount—for applying to soil in the second subregion at the second time—and a third applied nitrogen amount for applying to soil in the third subregion at the second time. The system can then: derive a treatment map—for implementation at approximately the second time—indicating application of the first, second, and third applied nitrogen amounts in the first, second, and third subregions, of the crop, respectively; and transmit this treatment map to a user for executing in the crop at approximately the second time. Additionally and/or alternatively, in this example, the system can upload the treatment map to an autonomous vehicle (e.g., an autonomous tractor or drone) configured to autonomously traverse the crop and apply nitrogen to soil in the crop according to the treatment map.

In one implementation, the system can derive a treatment map specifying a type of treatment and a treatment dosage (e.g., an amount and/or duration of treatment) for application within a particular region of a crop(s) and/or geographic region. For example, the system can: interpret a first pressure of a first stressor in a first region of a crop, based on features extracted from a first section of a first image depicting sensor plants in the first region; interpret a second pressure of the first stressor in a second region of the crop, based on features extracted from a second section of the first image depicting sensor plants in the second region; select a first mitigation technique (e.g., application of pesticide or fungicide, watering plants, fertilizing plants) configured to mitigate pressures of the first stressor in the crop; define a dosage gradient for application of the first mitigation technique across the crop based on the first pressure and the second pressure; and generate a treatment map based on the first mitigation technique and the dosage gradient. For example, the system can generate a treatment map defining: a first dosage of the first mitigation action in the first region of the crop; and—in response to the second pressure falling below the first pressure—a second dosage of the first mitigation action, less than the first dosage, in the second region of the crop.

### 6.4 Crop Resilience

In one variation, the system can characterize crop resilience of a particular crop to a set of plant stressors (e.g., abiotic and/or biotic stressors), such as drought, overheating, nutrient deficiency (e.g., nitrogen deficiency, phosphorous deficiency), excessive watering, salinity, soil pH, soil contamination, insects, fungi, weed growth, etc.

In particular, in this implementation, the system can characterize crop resilience to a particular stressor, in the set of plant stressors, based on a target plant condition—linked to this particular stressor—defined for the crop. For example, the system can quantify a resilience of plants in a crop to nitrogen deficiency as an inverse function of a target nitrogen amount defined for plants in the crop. More specifically, in this example, the system can quantify the resilience of plants in the crop to nitrogen deficiency as relatively high if the target nitrogen amount defined for these plants is relatively low. Alternatively, in this example, the system can quantify the resilience of plants in the crop to nitrogen deficiency as relatively low if the target nitrogen amount defined for these plants is relatively high.

Additionally and/or alternatively, in another implementation, the system can characterize crop resilience to a particular stressor, in the set of plant stressors, based on sensitivity of plants in the crop to deviation from a target plant condition linked to this particular stressor. For example, the system can: interpret a sensitivity of plants in a crop to nitrogen deficiency—such as below a target nitrogen amount defined for plants in the crop—based on observed changes to plant health; and quantify a resilience of plants in the crop to nitrogen deficiency as an inverse function of the sensitivity. The system can similarly repeat this process for each stressor, in the set of plant stressors, to characterize crop or plant resilience to the set of plant stressors in this particular crop.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method comprising:
accessing a feed of images of sensor plants of a sensor plant type sown in a set of agricultural fields within a geographic region, the feed of images recorded during a first time period, sensor plants of the sensor plant type configured to signal presence of a set of stressors at sensor plants;
interpreting a first pressure of a first stressor, in the set of stressors, in a first subregion, within the geographic region, based on features extracted from a first subset of images, in the feed of images, depicting sensor plants in the first subregion;
interpreting a second pressure of the first stressor in a second subregion, within the geographic region, based on features extracted from a second subset of images, in the feed of images, depicting sensor plants in the second subregion;
deriving a first pressure map for the geographic region based on the first pressure and the second pressure, the first pressure map representing presence of the set of stressors within the geographic region during the first time period;
accessing a yield model linking pressures of the set of stressors within the geographic region and crop yield for crops of a set of crop types in the target region; and
predicting a first crop yield for crops of a first crop type, in the set of crop types, in the geographic region based on the first pressure map and the yield model.

2. The method of claim 1:
wherein predicting the first crop yield for crops of the first crop type based on the first pressure map and the yield model comprises predicting the first crop yield for crops of the first crop type based on a first subset of features extracted from regions of the first pressure map corresponding to crops of the first crop type and the yield model; and
further comprising:
predicting a second crop yield for crops of a second crop type, in the set of crop types, in the geographic region, based on a second subset of features extracted from regions of the first pressure map corresponding to crops of the second crop type and the yield model; and
generating a first yield profile, in a set of yield profiles, for the geographic region based on the first crop yield for crops of the first crop type and the second crop yield for crops of the second crop type.

3. The method of claim 1:
wherein deriving the first pressure map comprises:
predicting a third pressure of the first stressor at a third subregion, within the geographic region, based on the first pressure of the first stressor in the first subregion and the second pressure of the first stressor in the second subregion; and
deriving the first pressure map for the geographic region based on the first pressure, the second pressure, and the third pressure; and
wherein predicting the first crop yield for crops of the first crop type in the geographic region comprises predicting the first crop yield for crops of the first crop type in the geographic region comprising:
a first crop of the first crop type located in the first subregion and comprising a first set of sensor plants of the sensor plant type;
a second crop of the first crop type located in the second subregion and comprising a second set of sensor plants of the sensor plant type; and
a third crop of the first crop type located in the third subregion.

4. The method of claim 1:
further comprising:
interpreting a third pressure of a second stressor, in the set of stressors, in the first subregion based on features extracted from the first subset of images; and
interpreting a fourth pressure of the second stressor, in the set of stressors, in the second subregion based on features extracted from the second subset of images; and
wherein deriving the first pressure map for the geographic region based on the first pressure and the second pressure comprises deriving the first pressure map for the geographic region based on the first pressure of the first stressor, the second pressure of the first stressor, the third pressure of the second stressor, and the fourth pressure of the second stressor.

5. The method of claim 4:
wherein interpreting the first pressure of the first stressor in the first subregion based on features extracted from the first subset of images comprises:
extracting a first set of fluorescence measurements within a first wavelength range from the first subset of images; and
interpreting the first pressure of the first stressor in the first subregion based on the first set of fluorescence measurements; and
wherein interpreting the third pressure of the second stressor in the first subregion based on features extracted from the first subset of images comprises:
extracting a second set of fluorescence measurements within a second wavelength range from the first subset of images; and
interpreting the third pressure of the second stressor in the first subregion based on the second set of fluorescence measurements.

6. The method of claim 1, further comprising, during an initial time period:
for each growing period, in a series of growing periods, within the initial time period:
recording a timeseries of pressure data representing pressures of the set of stressors within the geographic region throughout the growing period;
recording a final crop yield for crops of the crop type within the geographic region; and
storing the timeseries of pressure data and the final crop yield in a growing period packet in a series of growing period packets; and
based on the series of growing period packets, deriving a model linking pressures of the set of stressors within the geographic region to crop yield for the crop type within the geographic region.

7. The method of claim 1:
further comprising, accessing a timeseries of weather data recorded for the geographic region during the first time period; and
wherein predicting the first crop yield based on the first pressure map and the yield model comprises predicting the first crop yield based on the first pressure map, the timeseries of weather data, and the yield model.

8. The method of claim 1, further comprising:
predicting a third pressure of the first stressor in the first subregion at a second time succeeding the first time based on the first pressure map;
predicting a fourth pressure of the first stressor in the second subregion at the second time based on the first pressure map;
deriving a second pressure map for the geographic region based on the third pressure of the first stressor and the fourth pressure of the first stressor;
generating a treatment map for implementation at the second time based on the second pressure map; and
transmitting the treatment map to a set of users affiliated with crops in the geographic region.

9. The method of claim 8:
wherein generating the treatment map comprises:
selecting a first mitigation technique, in a set of mitigation techniques, configured to mitigate pressures of the first stressor in the geographic region; and
defining a dosage gradient comprising an array of dosages for application of the first mitigation technique across the geographic region based on the first pressure map; and
wherein transmitting the treatment map to the set of users affiliated with crops in the geographic region comprises:
transmitting the treatment map to a first subset of users, in the set of users, affiliated with application of the first mitigation technique within the geographic region; and
transmitting the treatment map to a second subset of users, in the set of users, affiliated with manufacturing of chemicals associated with the first mitigation technique.

10. The method of claim 1, further comprising:
accessing a target pressure range defined for pressures of the first stressor in the first subregion;
characterizing a difference between the first pressure and the target pressure range; and
in response to the difference exceeding a threshold difference:
selecting a first mitigation action, in a set of mitigation actions, configured to mitigate pressures of the first stressor;
selecting a first dosage of the mitigation action based on the difference;
generating a prompt to implement the first mitigation action at the first dosage in crops of the crop type within the first subregion; and
transmitting the prompt to a set of users affiliated with crops in the first subregion.

11. The method of claim 1, further comprising:
at a second time succeeding the first time, in response to harvesting crops of the crop type within the geographic region, accessing a final crop yield for harvested crops of the crop type for the growing period;
accessing a timeseries of pressure maps, comprising the first pressure map, derived for the geographic region during the growing period; and
rectifying the yield model based on the timeseries of pressure maps and the final crop yield.

12. The method of claim 1, further comprising:
based on the first pressure map:
selecting a first mitigation action, in a set of mitigation actions, configured to mitigate pressures of the first stressor;
generating a first prompt to implement the first mitigation action in crops of the crop type within the geographic region during a second time period succeeding the first time period; and
transmitting the first prompt to a set of users affiliated with crops of the crop type in the geographic region;
interpreting a third pressure of the first stressor in the first subregion based on features extracted from a third subset of images, in the feed of images, depicting sensor plants in the first subregion;
interpreting a fourth pressure of the first stressor in the second subregion based on features extracted from a fourth subset of images, in the feed of images, depicting sensor plants in the second subregion;
characterizing a first difference between the third pressure and the first pressure in the first subregion;
characterizing a second difference between the second pressure and the fourth pressure in the second subregion;
in response to the first difference exceeding a threshold difference:
generating a second prompt to implement the first mitigation action in crops of the crop type within the first subregion during a third time period succeeding the second time period; and
transmitting the second prompt to a first subset of users, in the set of users, affiliated with crops of the crop type in the first subregion; and
in response to the second difference falling below the threshold difference:
selecting a second mitigation action, in the set of mitigation actions, in replacement of the first mitigation action and configured to mitigate pressures of the first stressor;
generating a third prompt to implement the second mitigation action in crops of the crop type within the second subregion during the third time period; and
transmitting the third prompt to a second subset of users, in the set of users, affiliated with crops of the crop type in the second subregion.

13. The method of claim 1:
wherein accessing the feed of images of sensor plants comprises accessing the feed of images of sensor plants of the sensor plant type configured to:
selectively output fluorescence signals across a set of wavelength ranges based on the set of stressors; and
output a baseline fluorescence signal within a target wavelength range linked to crops of the crop type, wavelengths within the target wavelength range outside the set of wavelength ranges;
wherein interpreting the first pressure of the first stressor in the first subregion based on features extracted from the first subset of images comprises:
identifying a first set of crops of the crop type within the first subregion based on detection of the baseline fluorescence signal within the first subset of images; and
interpreting the first pressure of the first stressor in the first set of crops based on detection of fluorescence signals, across the set of wavelength ranges, within the first subset of images; and
wherein interpreting the second pressure of the first stressor in the second subregion based on features extracted from the second subset of images comprises:
identifying a second set of crops of the crop type within the second subregion based on detection of the baseline fluorescence signal within the second subset of images; and
interpreting the second pressure of the first stressor in the second set of crops based on detection of fluorescence signals, across the set of wavelength ranges, within the second subset of images.

14. The method of claim 1, wherein accessing the feed of images of sensor plants of the sensor plant type comprises accessing the feed of images of sensor plants of the sensor plant type comprising:
a first promoter, in a set of promoters, configured to activate responsive to pressures of the first stressor; and
a first reporter, in a set of reporters, linked to the first promoter and configured to express a detectable, fluorescence signal responsive to activation of the first promoter and corresponding to pressure of the first stressor.

15. The method of claim 1:
wherein interpreting the first pressure of the first stressor comprises interpreting a first magnitude of nitrogen uptake in plants in the first subregion;
wherein interpreting the second pressure of the first stressor comprises interpreting a second magnitude of nitrogen uptake in plants in the second subregion; and
wherein predicting the total crop yield comprises:
accessing a target nitrogen uptake defined for plants in the geographic region;
predicting a first health score for plants in the first subregion based on the first magnitude of nitrogen uptake and the target nitrogen uptake;
predicting a second health score for plants in the second subregion based on the second magnitude of nitrogen uptake and the target nitrogen uptake; and
predicting the total crop yield for the geographic region based on the first health score, the second health score, and the yield model.

16. A method comprising:
accessing a feed of images of a population of sensor plants of a crop type sown in an agricultural field, the feed of images recorded by an aerial sensor during a first time period, the population of sensor plants configured to signal presence of a set of conditions and comprising a first set of sensor plants arranged in a first region of the agricultural field;
interpreting a first set of conditions at plants in the first region based on features extracted from a first subset of images, in the feed of images, depicting sensor plants in the first region;
accessing a set of target conditions defined for plants in the first region of the agricultural field;
predicting a first health score for plants in the first region based on a first difference between the first set of conditions and the set of target conditions;
based on the first health score, selecting a first treatment pathway, in a set of treatment pathways, for plants in the first region, the first treatment pathway configured to drive conditions of plants in the agricultural field toward the set of target conditions;
generating a prompt to implement the first treatment pathway during a second time period succeeding the first time period; and
transmitting the prompt to a user affiliated with the agricultural field.

17. The method of claim 16:
wherein accessing the feed of images of the population of sensor plants comprising the first set of sensor plants in the first region comprises accessing the feed of images of the population of sensor plants comprising the first set of sensor plants arranged in the first region and a second set of sensor plants arranged in a second region of the agricultural field;
further comprising:
interpreting a second set of conditions at plants in the second region based on a second set of signals detected in a second subset of images, in the feed of images, depicting sensor plants in the second region;
accessing a second set of target conditions defined for plants in the second region;
predicting a second health score for plants in the second region of the agricultural field based on a second difference between the second set of conditions and the second set of target conditions; and
based on the second health score, selecting a second treatment pathway for plants in the second region; and
wherein generating the prompt to implement the first treatment pathway during the second time period comprises generating the prompt to implement the first treatment pathway in the first region and the second treatment pathway in the second region during the second time period.

18. The method of claim 17:
wherein selecting the first treatment pathway for plants in the first region based on the first health score comprises, in response to the first health score falling below a threshold health score, selecting the first treatment pathway for plants in the first region; and
wherein selecting the second treatment pathway for plants in the second subregion based on the second health score comprises, in response to the second health score exceeding the threshold health score, selecting the second treatment pathway for plants in the first subregion, the second treatment pathway configured to maintain the second set of plant conditions in plants in the second subregion.

19. The method of claim 16:
wherein accessing the feed of images of the population of sensor plants comprising the first set of sensor plants in the first subregion comprises accessing the feed of images of the population of sensor plants comprising the first set of sensor plants arranged in the first region and a second set of sensor plants arranged in a second region of the agricultural field;
wherein interpreting the first set of conditions at plants in the first region comprises interpreting a first pressure of a first stressor, in a set of stressors, in plants in the first region and a second pressure of a second stressor, in the set of stressors, in plants in the first region; and
further comprising:
interpreting a second set of conditions at plants in the second region based on features extracted from a second subset of images, in the feed of images, depicting sensor plants in the second region, the second set of conditions comprising a third pressure of the first stressor in plants in the second region; and a fourth pressure of the second stressor in plants in the second region;
accessing a second set of target conditions defined for plants in the second region;
predicting a second health score for plants in the second region of the agricultural field based on a second difference between the second set of conditions and the second set of target conditions;
accessing a yield model linking plant health to crop yield for crops of the crop type in the agricultural field; and
predicting a first crop yield for crops of the crop type based on the first health score, the second health score, and the yield model.

20. A method comprising:
accessing a feed of images of a population of sensor plants sown in crops of a crop type within a target region and configured to signal presence of a set of stressors at sensor plants, the feed of images captured by an optical sensor during a first time period;
interpreting a first timeseries of pressure data for plants in a first subregion, in a set of subregions, of the target region based on features extracted from a first subset of images, in the feed of images, captured during a first time period, the first timeseries of pressure data representing changes in pressures of a set of stressors at plants in the first subregion during the first time period;
interpreting a second timeseries of pressure data for plants in a second subregion, in the set of subregions, of the target region based on features extracted from a second subset of images, in the feed of images, captured during the first time period, the second timeseries of pressure data representing changes in pressures of the set of stressors at plants in the second subregion during the first time period;
accessing a yield model linking pressures of the set of stressors in the target region and crop yield for crops of the crop type in the target region; and
predicting a first crop yield for crops of the crop type, in the set of crop types, in the target region, during a target harvest period succeeding the first time period, based on the first timeseries of pressure data, the second timeseries of pressure data, and the yield model.
